(19) United States
(12) Patent Application Publication
(10) Pub. No.: US 2011/0044566 A1
(43) Pub. Date: Feb. 24, 2011

(54) BAG

(75) Inventors: Theodore J. Fish, Willowbrook, IL (US); Kara Ferrari, Arcisate (IT); Thomas P. Koziol, Willowbrook, IL (US)

Correspondence Address: THE CLOROX COMPANY, P.O. BOX 24305, OAKLAND, CA, 94623-1305, US

(73) Assignee: The Glad Products Company, Oakland, CA (US)

(21) Appl. No.: 12/707,061

(22) Filed: Feb. 17, 2010

Related U.S. Application Data
(60) Provisional application No. 61/154,287, filed on Feb. 20, 2009.

(51) Int. Cl. B65D 33/16; B31B 1/90

(52) U.S. Cl. 383/63; 493/214

(57) ABSTRACT

A thermoplastic bag for storing food items may include a first sidewall and a second sidewall joined to the first sidewall to define an interior volume. The first and second sidewalls may be made from pliable thermoplastic material and may be joined together about their edges. To access the interior volume, the first and second top edges of the bag may remain un-joined to provide an opening. The bag may include a deformed portion. The deformed portion may cause some of the material to be offset or lie out of plane with respect to the material prior to deformation. The deformed portion may assist a user in grasping the top of the bag.

### CROSS REFERENCE TO RELATED APPLICATIONS

This application claims the benefit of U.S. Provisional Application No. 61/154,287, filed on Feb. 20, 2009, which is hereby incorporated by reference in its entirety.

### BACKGROUND

Thermoplastic bags are used in a wide variety of applications including, for example, to store perishable food items. A bag of this type typically includes opposing sidewalls of pliable, thermoplastic web or sheet material that are joined to each other to define an interior volume for receiving the item to be stored. To access the interior volume, an opening may be disposed between the overlaid sidewalls. To close the opening, the bag may include interlocking closure strips that are attached to the respective sidewall proximate the opening. Such closure strips can be pressed together and pulled apart to occlude and deocclude each other and thereby close and open the bag. There is a need for a thermoplastic bag with an opening which is simple and easy to open and close.

### BRIEF SUMMARY

A flexible, thermoplastic storage bag may include opposing first and second sidewalls of pliable thermoplastic web or sheet material that may be joined together along various edges to provide an interior volume. The first and second sidewalls may have a generally smooth or planar shape or appearance due to the web or sheet material from which they are produced. For accessing the interior volume, at least two opposing edges may remain un-joined to provide an opening. To close the opening and seal the bag, the bag may include first and second engageable closure strips. The bag may include a deformed portion.

The deformed portion may be formed to have a deformation pattern. When a user attempts to open or close the bag, the deformed portion proximate the opening will facilitate gripping of the bag at the opening. The deformed portion may provide the material with a relative rigidity. The deformed portion may provide a tactile indication to a user as the closure strips occlude and de-occlude.

The deformation pattern of the deformed portion may take any suitable shape or appearance including for example, an undulating or repeating wave shape of spaced-apart crests. In another embodiment, the deformation pattern may include a plurality of protrusions.

To produce a thermoplastic bag having a deformed portion proximate the opening, a high speed manufacturing process may be employed which processes the planar, continuous webs of thermoplastic material into a finished bag. The process may direct the portion of the bag proximate the opening between opposing rollers having a deformation pattern formed thereon so that the thermoplastic material may be deformed. Additional processing equipment may be included that processes the web into a finished bag.

A possible advantage of forming the thermoplastic bag with a deformed portion proximate the opening is that it may simplify gripping and manipulating the opening and the interlocking closure strips. Another possible advantage is that the deformed portion may prevent the bag from adhering or blocking together at the edges which provide the opening. These and other advantages and features of the disclosure will become apparent from the description and the accompanying drawings.

### BRIEF DESCRIPTION OF THE DRAWINGS

FIG. 1 is a perspective view of a thermoplastic bag having a deformed portion in the form of a plurality of undulated waves.

FIG. 2 is a top plan view of the thermoplastic bag of FIG. 1 directed toward the closed opening.

FIG. 3 is a top plan view of the opening of the thermoplastic bag of FIG. 1.

FIG. 4 is a front elevational view of the thermoplastic bag of FIG. 1 having a deformed portion extending between the top edges and the interlocking closure strips.

FIG. 5 is a cross-sectional view of the thermoplastic bag taken along line 5-5 of FIG. 4 illustrating the interlocking closure strips in the occluded position.

FIG. 6 is another cross-sectional view of the thermoplastic bag similar to that of FIG. 5 showing the deformed portion proximate to the top edges being folded outwardly along a bending line.

FIG. 7 is a cross-sectional view similar to FIG. 5 with the interlocking closure strips in the deoccluded position.

FIG. 8 is a cross-sectional view of another embodiment.

FIG. 9 is a front elevational view of another embodiment of the thermoplastic bag having a deformed portion located above and below the interlocking closure strips.

FIG. 10 is a cross-sectional view taken along line 10-10 in FIG. 9.

FIG. 11 is a plan view showing a thermoplastic web being directed between opposing rollers to impart the deformation pattern.

FIG. 12 is an enlarged view of the rollers in FIG. 11.

FIG. 13 is a plan view of another embodiment of a thermoplastic web being directed between opposing rollers to impart the deformation pattern.

FIG. 14 is an enlarged view of the rollers in FIG. 13.

FIG. 15 is a plan view of another embodiment of a thermoplastic web being directed between opposing rollers to impart the deformation pattern.

FIG. 16 is an enlarged view of the rollers in FIG. 15.

FIG. 17 is a side elevational view of a roller having a deformation pattern.

FIG. 18 is a side elevational view of another embodiment of a roller having a deformation pattern.

FIG. 19 is a side elevational view of another embodiment of a roller having a deformation pattern.

FIG. 20 is a perspective view of another embodiment of a thermoplastic bag having a deformed portion in the form of a plurality of protrusions.

FIG. 21 is a front elevational view of the thermoplastic bag of FIG. 20 showing the deformed portion extending between the top edges and the interlocking closure strips.

FIG. 22 is a cross-sectional view of the thermoplastic bag taken along line 22-22 of FIG. 21 showing the interlocking closure strips and the deformed portion.

FIG. 23 is a cross-sectional view of the thermoplastic bag similar to that of FIG. 22 showing the top edges folded outwardly along a bend line delineated by the deformed portion.

FIG. 24 is a front elevational view of another embodiment of the thermoplastic bag having a deformed portion in the form of a plurality of protrusions above and below the interlocking closure strips.

FIG. 25 is a perspective view of opposing rollers having a deformation pattern.

FIG. 26 is a perspective view of another embodiment of a roller having a deformation pattern.

FIG. 27 is a front elevational view of a thermoplastic bag having a deformed portion in the form of a plurality of protrusions imparted by the roller having a deformation pattern shown in FIG. 26.

FIG. 28 is a perspective view of another embodiment of a roller having a deformation pattern.

FIG. 29 is a front elevational view of a thermoplastic bag having a deformed portion in the form of protrusions imparted by the roller having a deformation pattern shown in FIG. 28.

FIG. 30 is a perspective view of another embodiment of a roller having a deformation pattern of protrusions arranged as interlinked circles.

FIG. 31 is a front elevational view of a thermoplastic bag having a deformed portion in the form of protrusions arranged as interlinked circles imparted by the roller having a deformation pattern shown in FIG. 30.

FIG. 32 is a perspective view of another embodiment of the roller having the deformation pattern with both large and small bumps on its surface.

FIG. 33 is a front elevational view of a thermoplastic bag having a deformed portion from the roller having the deformation pattern shown in FIG. 32

FIG. 34 is a schematic representation of a high speed manufacturing process for producing thermoplastic storage bags from a single web of thermoplastic material that utilizes two sets of opposing roller pairs.

FIG. 35 is a schematic representation of a high speed manufacturing process similar to FIG. 34 that utilizes one pair of opposing rollers.

FIG. 36 is a schematic representation of another embodiment of a high speed manufacturing process for producing thermoplastic storage bags that utilizes multiple webs of thermoplastic material and two sets of opposing roller pairs.

FIG. 37 is a schematic representation of another embodiment of a high speed manufacturing process similar to FIG. 36 that utilizes one set of opposing roller pairs.

FIG. 38 is a cross-sectional view of an embodiment of the interlocking closure strips provided to close the opening of the thermoplastic bag.

FIG. 39 is a cross-sectional view of another embodiment of the interlocking closure strips provided to close the opening of the thermoplastic bag.

FIG. 40 is a cross-sectional view of another embodiment of the interlocking closure strips provided to close the opening of the thermoplastic bag.

### DESCRIPTION

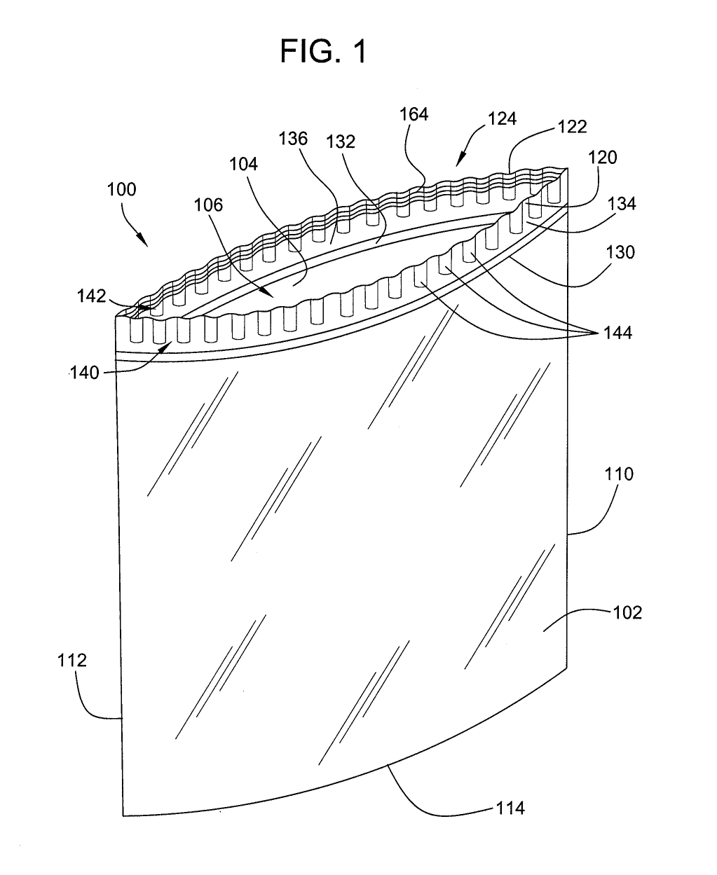

Referring to FIG. 1, the bag 100 may include a first sidewall 102 of pliable thermoplastic material and an opposing second sidewall 104 overlaying and joined to the first sidewall to delineate an interior volume 106. The sidewalls 102, 104 may be rectangular in shape and may be joined along a first side edge 110, a second side edge 112, and a bottom edge 114 extending between the first and second side edges 110, 112. However, in other embodiments, the sidewalls may have other shapes, and the bag may have different numbers of edges and sidewalls. The edges may be formed by any suitable method including, for example, heat sealing the thermoplastic material together.

To access the interior volume 106, the first and second top edges 120, 122 of the respective first and second sidewalls 102, 104, which may be parallel and co-extensive with one another, may remain un-joined to provide an opening 124. To releasably close the opening 124 to, for example, better preserve food items, the first and second sidewalls 102, 104 may include first and second interlocking closure strips 130, 132. The first and second closure strips 130, 132 may be formed from extruded, flexible thermoplastic and may extend between the first and second side edges 110, 112. The first and second interlocking closure strips 130, 132 may releasably engage to form a seal which closes the opening 124. In the illustrated embodiment, the first and second closure strips 130, 132 may be attached to the respective first and second sidewalls 102, 104 generally proximate the opening 124 and may be spaced slightly below the first and second un-joined top edges 120, 122. The bag material located between the first closure strip 130 and the top edge 120 is sometimes referred to as the flange 134 and the bag material located between the first closure strip 132 and the top edge 122 is sometimes referred to as the flange 136. Of course, in other embodiments or in combination with the interlocking closure strips, other methods such as the use of pressure sensitive or cold seal adhesives such as those disclosed in U.S. Pat. No. 6,149,304, herein incorporated by reference in its entirety, heat-sealing, or cling may be employed to assist in closing the open top edge.

The first and second sidewalls 102, 104 may be made from any suitable thermoplastic material formed or drawn into a flexible, pliable thin walled sheet or web. The thickness of the thermoplastic web may have a first range of about 0.0005 inches (0.0013 cm) to about 0.005 inches (0.0127 cm), and a second range of about 0.0018 inches (0.0046 cm) to about 0.0026 inches (0.0066 cm). In one embodiment, the thickness may be about 0.0026 inches (0.0066 cm). Examples of suitable thermoplastic materials may include polyethylenes, such as, high density polyethylene (HDPE), low density polyethylene (LDPE), linear low density polyethylene (LLDPE), polypropylene (PP), ethylene vinyl acetate (EVA), nylon, polyester, polyamide, ethylene vinyl alcohol, or other materials or combinations thereof, and may be formed in single or multiple layers. When intended for storing food items, the thermoplastic material of the bag typically may be transparent, though in other embodiments the thermoplastic material may be translucent, opaque, or tinted. Furthermore, the material used for the sidewalls may be a gas impermeable material.

The sidewalls 102, 104 may be smooth and planar having an overall two dimensional shape. To enable a user to easily grasp the top edges 120, 122 of the respective first and second sidewalls 102, 104 when, for example, disengaging the interlocking closure strips 130, 132 and opening the bag, a portion of at least one of the sidewalls proximate the top edges delineating the opening may be deformed by, for example, a deformation pattern. In the illustrated embodiment, both the first sidewall 102 and the second sidewall 104 may be formed with a first deformed portion 140 and a respective second deformed portion 142 proximate the top edges 120, 122. The deformed portion may deform and distort the otherwise planar appearance of the sidewall so that the top edges 120, 122 may be alternately located in and out of the plane defined by the rest of the sidewall. In other words, the deformed portion may cause some of the thermoplastic material to be offset with respect to the material prior to deformation. Because of the deformed portions 140, 142, the bag 100 may have relatively more three-dimensional area about the opening 124 and may provide the user with more sidewall surface to grasp. Additionally, the deformed portions 140, 142 may help prevent the top edges 120, 122 of the sidewalls 102, 104 from adhering or blocking together when the sidewalls are placed adjacent to each other and the bag is closed.

To create the deformed portions 140, 142 of the bag 100, the sidewalls 120, 122 may be formed by an appropriate device having a deformation pattern formed thereon, which will be explained below.

In the embodiment illustrated in FIG. 1, the deformed portions 140, 142 may be provided as an undulated or wavy pattern of waves or crests 144. The waves 144 may be parallel to the first and second side edges 110, 112 and may be spaced along the top edges 120, 122 from the first side edge to the second side edge. The peak or crest of each wave 144 may continue from the top edge 120, 122 toward the interlocking closure strips 130, 132 where the deformed pattern terminates. The undulating curve or inflection of the waves 144 may cause the deformed portion 140 to move back and forth to opposite sides of a plane defined by the smooth sidewall 102. The shape of the waves 144 may cause at least some portion of the top edges 120, 122 and the adjacent thermoplastic material to protrude or become offset with respect to the remainder of the planar sidewalls.

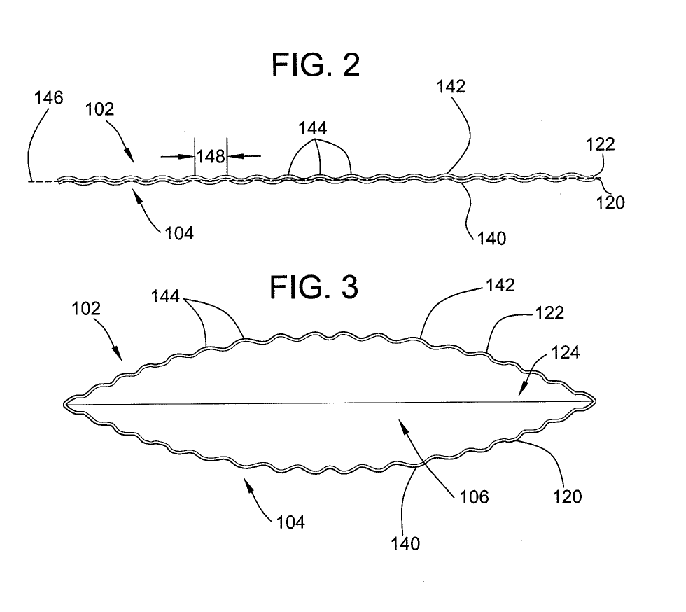

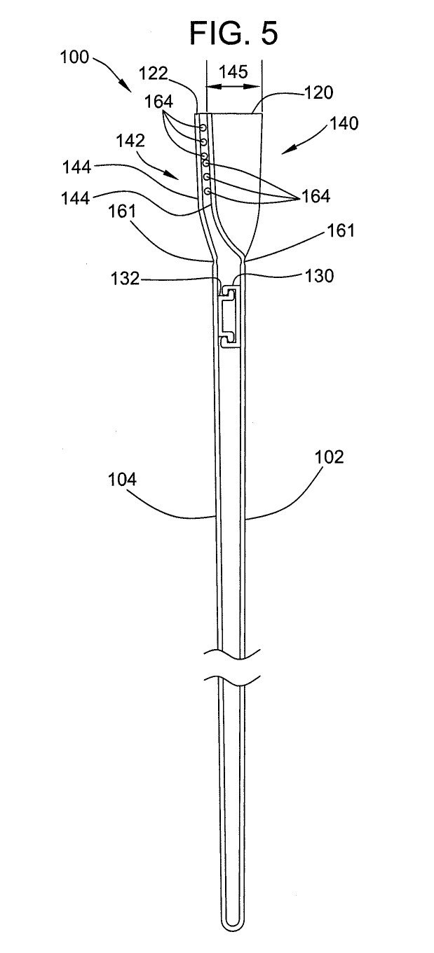

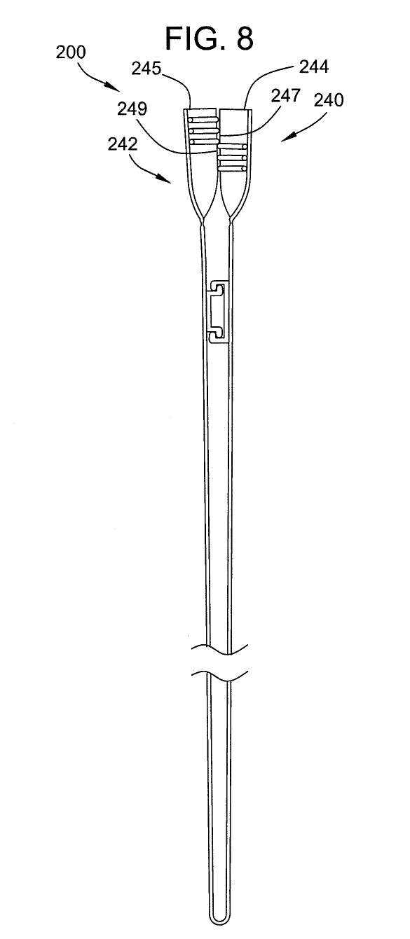

As can be seen in FIG. 2, which illustrates the bag 100 in a collapsed state in which the first and second sidewalls 102, 104 are placed adjacent each other, the peaks of the waves 144 fall on either side of a plane 146 indicated by a dashed line that represents the otherwise planar shape of the adjacent sidewalls. Referring to FIG. 5, the waves 144 may have a height 145 from peak to peak. The height 145 may have a first range from about 0.03 inches (0.08 cm) to about 0.2 inches (0.5 cm), a second range from about 0.05 inches (0.13 cm) to about 0.15 inches (0.38 cm), and a third range from about 0.08 inches (0.2 cm) to about 0.13 inches (0.32 cm). In one embodiment, the height 145 may be 0.1 inches (0.25 cm). The waves 144 may be separated or spaced apart from each other by a pitch distance 148 in a first range from about 0.1 inches (0.3 cm) to about 0.8 inches (2 cm), a second range from about 0.2 inches (0.5 cm) to about 0.6 inches (1.5 cm), and a third range from about 0.3 inches (0.8 cm) to about 0.5 inches (1.3 cm). In one embodiment, the pitch distance 148 may be 0.4 inches (1 cm). The first and second deformation portions may be coordinated so that, when the first and second top edges 120, 122 are place adjacent to one another as illustrated in FIGS. 2 and 5, the waves 144 of the two deformation patterns may nest together or accommodate one another. In other embodiments, the deformation patterns may not be nested. For example, in FIG. 8, the waves on the first side are 180 degrees out of phase with the waves on the second side. In other embodiments, the waves on the first side may be out of phase with the waves of the second side in a range from 0 degrees to 180 degrees. In another embodiment, the waves on the first side may have a first pitch and the waves on the second side may have a second pitch. The first pitch may be different than the second pitch. In another embodiment, the pitch may vary along the width of the bag. In another embodiment, the waves on the first side may have a first height and the waves on the second side may have a second height. The first height may be different than the second height. In another embodiment, the wave height may vary along the width of the bag.

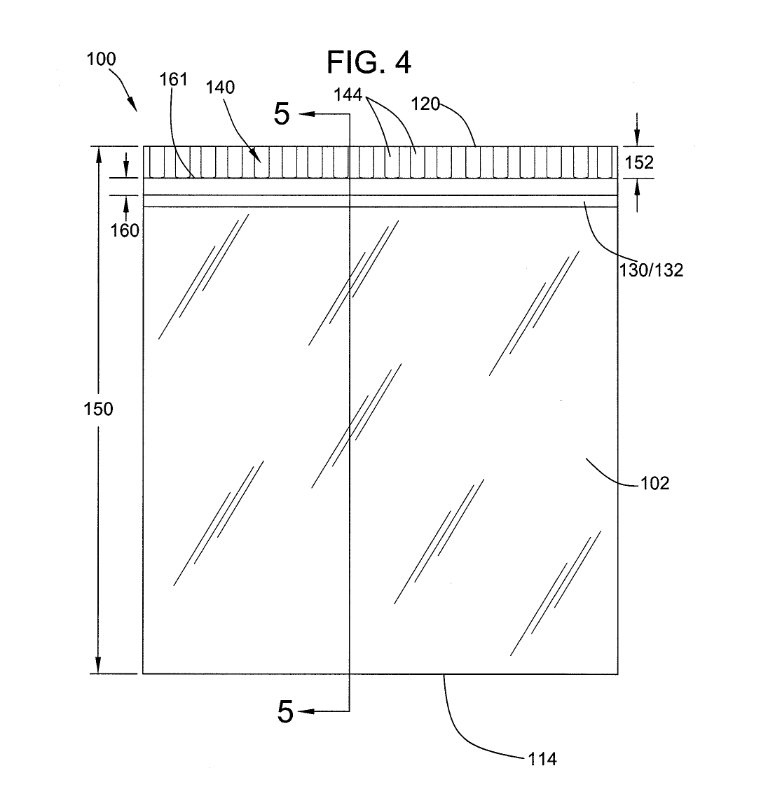

As may be appreciated from FIGS. 2 and 3, the undulating waves 144 of the deformed portions 140, 142 may cause the bag 100 to have an increased dimensional presence along the top edges 120, 122 when viewed towards the opening. This may make it easier for a user to place their fingers against the adjacent first and second top edges 120, 122 and to pull or pry the adjacent top edges apart from each other when opening the bag 100. As illustrated in FIG. 3, once the top edges 120, 122 have been separated and are pulled apart, the first and second sidewalls 102, 104 also separate to provide the interior volume 106 thereby providing capacity for retaining items for storage. The deformed portions 140, 142 may have an increased stiffness as compared to the remainder of the material. For example, a wavy or corrugated structure is usually stiffer than a non-corrugated structure. Any increased stiffness imparted near the top edges 120, 122 due to the deformed portions 140, 142 may simplify manipulation and separation by a user of the top edges. The deformed portions 140, 142 may feel rougher to the user as compared to the remainder of the material. Any increased roughness at the deformed portions 140, 142 may improve gripping by the user.

Referring to FIG. 4, the deformed portion 140 may extend from the top edge 120 of the first sidewall 102 partially toward the closed bottom edge 114 and may be located above the first and second interlocking closure strips 130, 132. Placing the deformed portion 140 above the closure strips 130, 132 in the illustrated embodiment avoids having the deformed portion distort or disrupt the structure of the closure strips. By way of example, the bag 100 may have a height 150 measured from the top edge 120 to the closed bottom edge 114. The height 150 may have a first range from about 3.5 inches (9 cm) to about 32 inches (83 cm), a second range from about 7 inches (18 cm) to about 20 inches (51 cm), and a third range from about 8 inches (20 cm) to about 15 inches (38 cm). In one embodiment, the height 150 may be 11.8 inches (30 cm). The deformation pattern 140 may extend a distance 152. The distance 152 may have a first range from about 0.13 inches (0.3 cm) to about 0.8 inches (2 cm), a second range from about 0.25 inches (0.6 cm) to about 0.7 inches (1.8 cm), and a third range from about 0.38 inches (1.0 cm) to about 0.6 inches (1.5 cm). In one embodiment, the distance 152 may be 0.5 inches (1.3 cm). The bottom of the deformation pattern may extend a distance 160 from the fastening strips. The distance 160 may have a first range from about 0.06 inches (0.15 cm) to about 0.8 inches (2 cm), a second range from about 0.13 inches (0.3 cm) to about 0.63 inches (0.95 cm), and a third range from about 0.19 inches (0.48 cm) to about 0.5 inches (1.3 cm). In one embodiment, the distance 160 may be 0.25 inches (0.64 cm).

In another embodiment, the deformed portion may be spaced a distance below the top edge of the bag. The distance may have a first range from about 0 inches (0 cm) to about 1.25 inches (3.18 cm), a second range from about 0.25 inches (0.63 cm) to about 0.625 inches (1.59 cm), and a third range from about 0.375 inches (0.95 cm) to about 0.5 inches (1.27 cm). In one embodiment, the distance may be 0.33 inches (0.84 cm).

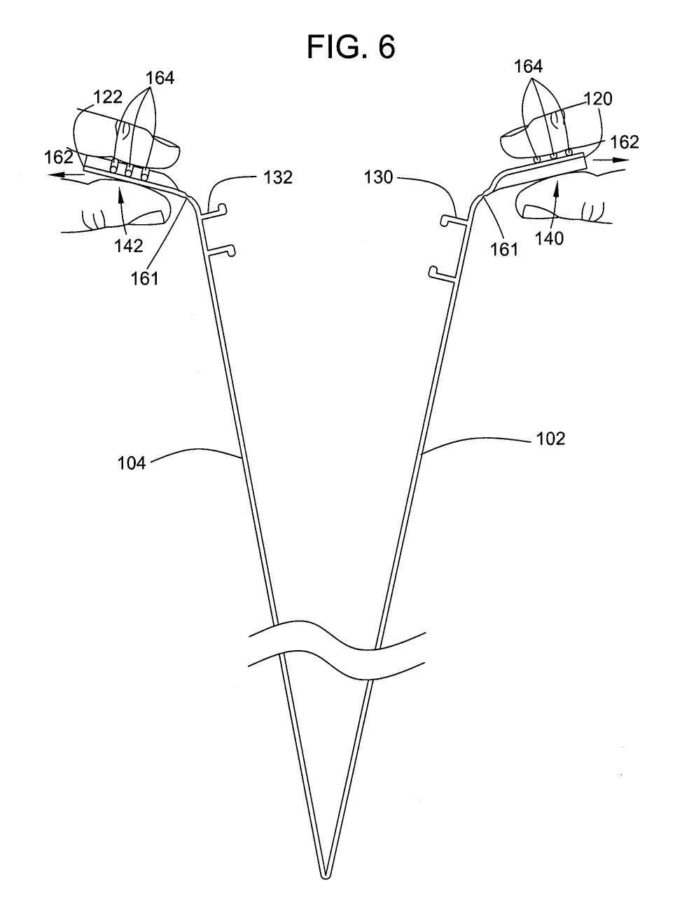

Referring to FIG. 6, the deformed portions 140, 142 may facilitate the bending of the first and second top edges 120, 122 outwards and away from each other. For example, the deformed portion 140 may extend from the top edges 120, 122 and may terminate in a bending line 161 as indicated in FIGS. 4 and 5. The bending line 161 may extend parallel to the top edge 120 and may be located above the first and second closure strips 130, 132. The bending line 161 may be created when the deformed portions 140, 142 are formed along the first and second top edges 120, 122. For example, the bending line 161 may result from the increased stiffness of the deformation portions 140, 142 and/or the reduced thickness at the bottom of the deformation portions. The bending line 161 may represent the transition between the deformed portions 140 and the portion of the material below the deformed portions.

Referring to FIG. 5, in its normal state when the first and second closure strips 130, 132 are engaged, the first and second top edges 120, 122 of the bag may continue the generally upward extension or direction of the first and second sidewalls 102, 104 above the bending line 161 such that the deformation portions 140, 142 extend generally in parallel with each other. Referring to FIG. 6, when a user pinches the first top edge 120 between two fingers and the second top edge 122 between two other fingers and pulls them apart in opposite directions, the first and second top edges 120, 122 may bend outwardly and away from each other. The bending lines 161 may make it easier for the user to bend the top edges or flanges outward and thus, easier for the user to separate the top edges or flanges. The user may then apply pulling forces 162 to separate the first and second closure strips 130, 132.

Also illustrated in FIGS. 1, 5 and 6 is another feature that may be included with the bag 100 to assist a user in gripping the first and second top edges 120, 122 during opening. One or more beads or strips 164 of thermoplastic material may be extruded or attached along the inner surfaces of the first and second sidewalls along the deformation pattern 140. The strips 164 may be vertically spaced apart from each other and may be located above the interlocking closure strips 130, 132. The strips 164 may protrude from the inner surface to provide further unevenness proximate the top edges 120, 122 that may be more easily gripped or grasped by the user.

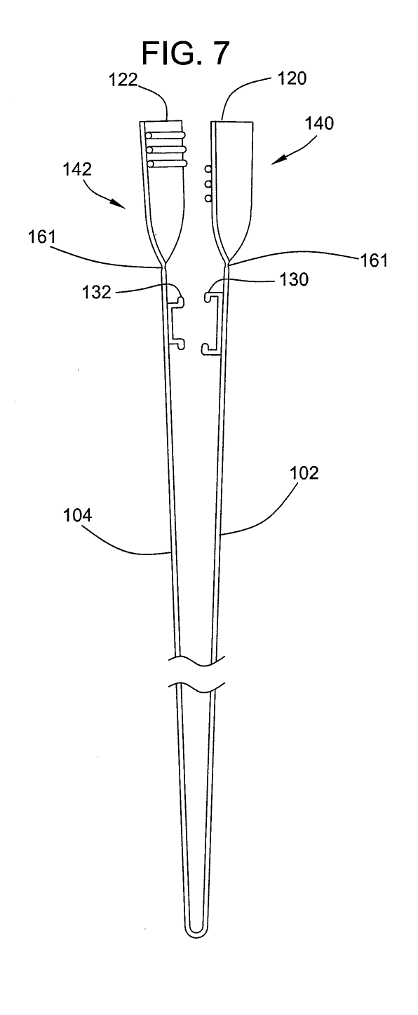

Referring to FIG. 7, the first and second closure 130, 132 strips are disengaged. The deformed portions 140, 142 may provide an increased dimensional presence near the top edges 120, 122. This may make it easier for a user to place their fingers near the top edges 120, 122 and to hold the bag open in order to place items in the bag or remove items from the bag.

Referring to FIG. 8, another embodiment of a bag is shown. The bag 200 may include deformed portions 240, 242 in which the waves 244, 245 are not nested.

In one embodiment, the peak 247 of wave 244 may engage the peak 249 of wave 245. In other embodiments, the peak 247 may engage other portions of the deformed portion 242.

In another embodiment, the bag may have a deformed portion on one side of the bag and the other side of the bag may not have a deformed portion. In another embodiment, the deformed portion may extend partially across the width of the bag. For example, the deformed portion may be in the center of the bag near the top edge, but the deformed portion may not be at the side seals. The lack of a deformed portion at the side seals may facilitate and/or improve the side seals as compared to side seals made through the deformed portion.

In another embodiment, the fastening strips may be attached to separate strips or tapes of plastic and the strips may be attached to the sidewalls of the bag. The deformed portions may be provided before the separate strips are attached to the bag and/or the deformed portions may be provided after the separate strips are attached to the bag.

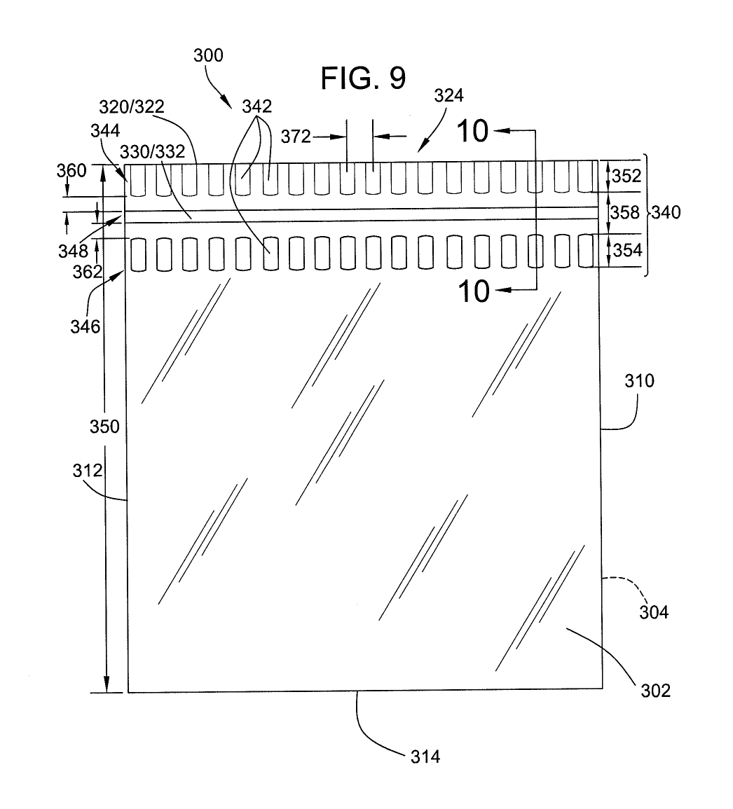

Referring to FIG. 9, there is illustrated another embodiment of a thermoplastic bag 300 configured with a deformed portion 340. The bag 300 may include a first sidewall 302 and an opposing second sidewall 304. The first and second sidewalls 302, 304 may be joined together along a first side edge 310, a second side edge 312, and a bottom edge 314 that extends between the first and second side edges. To provide an opening 324 for accessing the interior volume, the first and second sidewalls 302, 304 may remain un-joined along their respective top edges 320, 322. The opening 324 may be selectively sealed by engaging first and second interlocking closing strips 330, 332 that may be attached to the inner surfaces of the first and second sidewalls proximate to the top edges 320, 322.

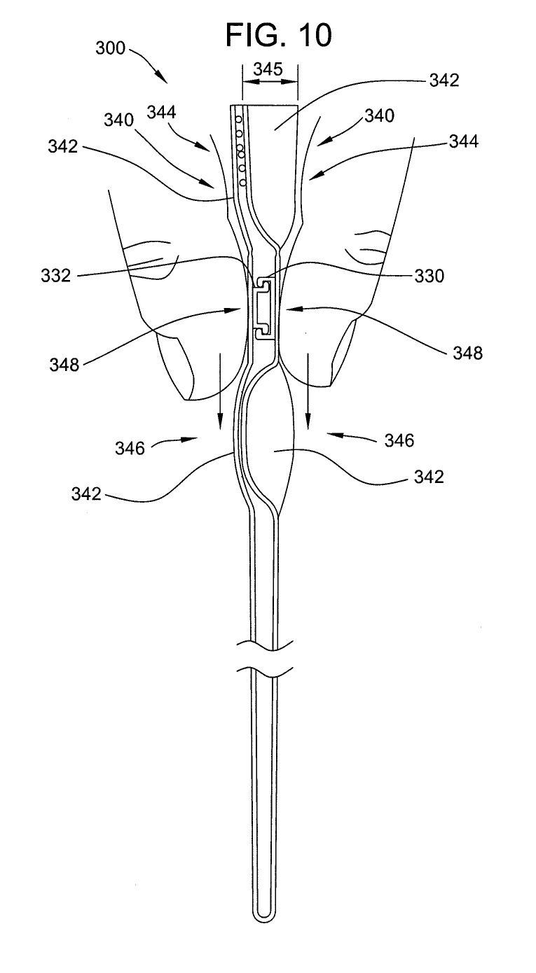

To facilitate grasping of the sidewalls 302, 304 proximate the top edges 320, 322, the bag may include a deformed portion 340. The deformed portion 340 may be in the form of an undulating shape of a plurality of spaced-apart waves or crests 342. The waves or crests 342 may cause the material proximate the top edges 320, 322 to become offset with the respect to the sidewalls 302, 304. In the illustrated embodiment, the waves 342 of the deformed portion 340 may be provided in two parallel rows 344, 346 located above and below the closure strips 330, 332. The first row 344 may be located above the closure strips 332, 334 and the second row 346 may be located below the closure strips 332, 334. Referring to FIGS. 9 and 10, the closure strips 330, 332 may be located in a valley or groove 348 provided between the protruding waves 342 in the first and second rows 344, 346. For engaging the closure strips 330, 332, a user may run their fingers as guided or directed by the groove 348 between the first and second rows 344, 346 along the closure strips.

Referring to FIG. 9, the dimensions of the deformed portion 340 may be selected to further facilitate use of the groove 348 to engage the interlocking closure strips 330, 332. In the illustrated embodiment, the bag 300 may have an overall height 350. The height 350 may have the same dimensional information as noted with respect to height 150 in FIG. 4. The first row 344 may have a height 352. The height 352 may have the same dimensional information as height 152 in FIG. 4. The second row 346 may have a height 354. The height 354 may have the same dimensional information as height 352. The first row 344 and second row 346 may be separated by a distance 358. The distance 358 may have a first range of about 0.25 inches (0.6 cm) to about 1.5 inches (4 cm), a second range of about 0.5 inches (1.3 cm) to about 1.25 inches (3 cm), and a third range of about 0.63 inches (1.6 cm) to about 1 inch (2.5 cm). In one embodiment, the distance 358 may be about 0.8 inches (2 cm). The bottom of the first row 344 may be located a distance 360 from the top of the fastening strip 330. The distance 360 may have the same dimensional information as the distance 160. The top of the second row 346 may be located a distance 362 from the bottom of the fastening strip 330. The distance 362 may have the same dimensional information as the distance 360. In one embodiment, the distance 360 may be the same as distance 362. In another embodiment, the distance 360 may be different than the distance 362. The pitch distance 372 of the waves 342 may have the same dimensional information as noted with respect to the pitch distance 148 in FIG. 2. Referring to FIG. 10, waves 342 may have a height 345 from peak to peak. The height 345 may have the same dimensional information as noted with respect to the height 145 in FIG. 5.

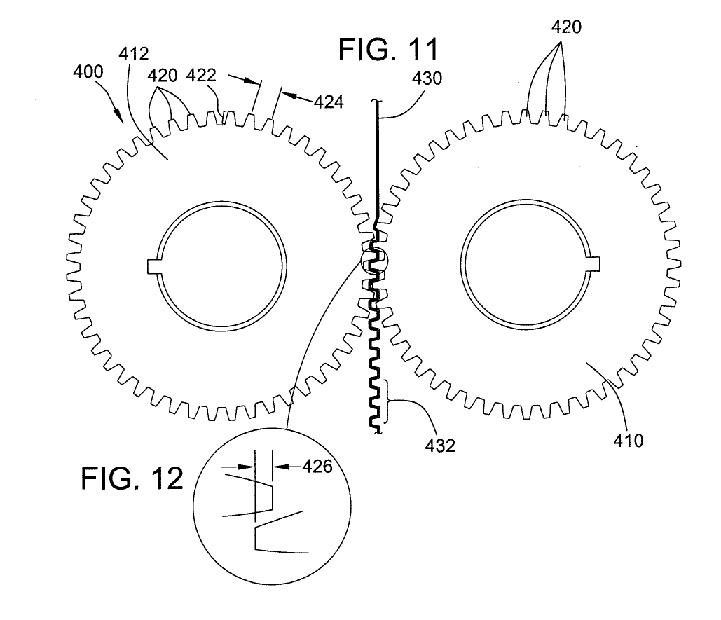

Referring to FIG. 11, there is illustrated a device 400 which may form the deformation portion as a series of undulating waves imparted to a thermoplastic web from which a thermoplastic bag may be manufactured. The device 400 may utilize a first roller 410 and an opposing second roller 412 that may be arranged in parallel and adjacent to each other and that may be made to rotate in opposite directions with respect to each other. The rollers 410, 412 may include a plurality of spaced-apart teeth 420 that may be formed about each of their surfaces and that may intermesh together when the rollers are placed adjacent to each other. The teeth 420 may have tapered sides. In the illustrated embodiment, the teeth 420 may have a tooth height 422. The tooth height 422 may have a first range of about 0.1 inches (0.25 cm) to about 0.36 inches (0.9 cm), a second range of about 0.14 inches (0.36 cm) to about 0.27 inches (0.7 cm), and a third range of about 0.18 inches (0.46 cm) to about 0.22 inches (0.56 cm). In one embodiment, the tooth height 422 may be about 0.22 inches (0.56 cm). The rollers may have a tooth pitch 424. The tooth pitch 424 may a first range of about 0.16 inches (0.4 cm) to about 0.52 inches (1.3 cm), a second range of about 0.2 inches (0.5 cm) to about 0.39 inches (1 cm), and a third range of about 0.26 inches (0.66 cm) to about 0.31 inches (0.8 cm). In one embodiment, the tooth pitch 424 may be about 0.31 inches (0.8 cm). The rollers 410, 412 may be set apart from each other so that the intermeshing teeth have a depth of engagement 426. Referring to FIG. 12, the depth of engagement 426 may have a first range of about 0.1 inch (0.25 cm) to about 0.33 inches (0.8 cm), a second range of about 0.13 inches (0.3 cm) to about 0.27 inches (0.51 cm), and a third range of about 0.17 inches (0.4 cm) to about 0.2 inches (0.5 cm). In one embodiment, the depth of engagement 426 may be about 0.2 inches (0.5 cm).

Referring to FIG. 11, the rollers 410, 412 may be made to rotate with respect to each other while a thermoplastic web 430 is directed between the rollers where the web may become deformed and distorted by the intermeshing teeth 420. The pitch spacing and depth of engagement between the teeth may correspond to the deformation pattern of alternating waves comprising the deformed portion. Thus, the intermeshing teeth may impart the deformation pattern into the web. The waves 432 of the deformed portion may have a pattern corresponding to the shape of the intermeshing teeth on the roller 410, 412.

In various embodiments, directing the web 430 between the teeth 420 may stretch out or work the thermoplastic material without ripping, tearing or cutting the web material. Forcing the thermoplastic material in between adjacent teeth may cause the web to increase in dimension. This stretching or working of the thermoplastic material may cause the material to demonstrate shape memory so that the pattern of undulating waves 432 imparted into the material may remain after processing through the rollers 410, 412. Additionally, stretching and working the material may provide an increased stiffness. To avoid ripping or cutting the web material within the area that becomes the deformed portion, the edges of the intermeshing teeth 420 may be chamfered or rounded.

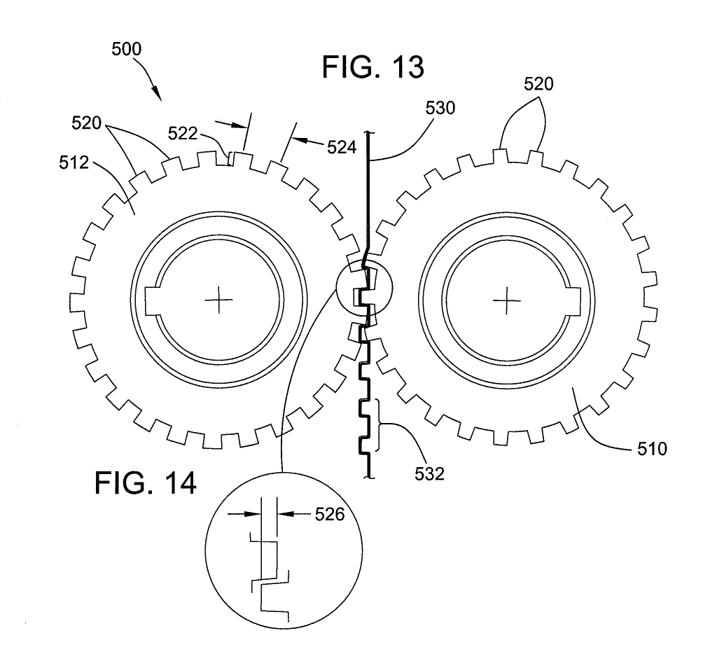

Referring to FIG. 13, there is illustrated another embodiment of a device 500 using two opposing rollers 510, 512 that may be adjacent to each other and that may be made to rotate in opposing directions. Each roller 510, 512 may have formed about its surface a plurality of teeth 520 that may intermesh with each other when the rollers are made to rotate. In the illustrated embodiment, the teeth 520 may be generally square or rectangular and may have a tooth height 522. The tooth height 522 may have the same dimensional information as tooth height 422. The teeth 520 may have a tooth pitch 524. The tooth pitch 524 may have the same dimensional information as tooth pitch 424. The rollers 510, 512 may be set apart from each other so that the intermeshing teeth have a depth of engagement 526. Referring to FIG. 14, the depth of engagement 526 may have the same dimensional information as depth of engagement 426. The intermeshing teeth may be chamfered or rounded to avoid ripping or cutting the web material.

Referring to FIG. 13, a web 530 of thermoplastic material may be directed between the rotating rollers 510, 512 to impart the deformation pattern including the plurality of waves 532 into the web material to form the deformed portion. The thermoplastic material may be stretched out or worked by the intermeshing teeth in order to demonstrate shape memory and retain the deformation pattern after processing. The waves 532 imparted into the web 530 may have the same pattern as the teeth 520 on the rollers. Because the tooth pitch 524 of the rollers 510, 512 in FIG. 13 is greater than the tooth pitch 424 of the rollers 410, 412 in FIG. 11, the pitch between the waves 532 may be larger than the pitch between waves 432 arising from the process shown in FIG. 11.

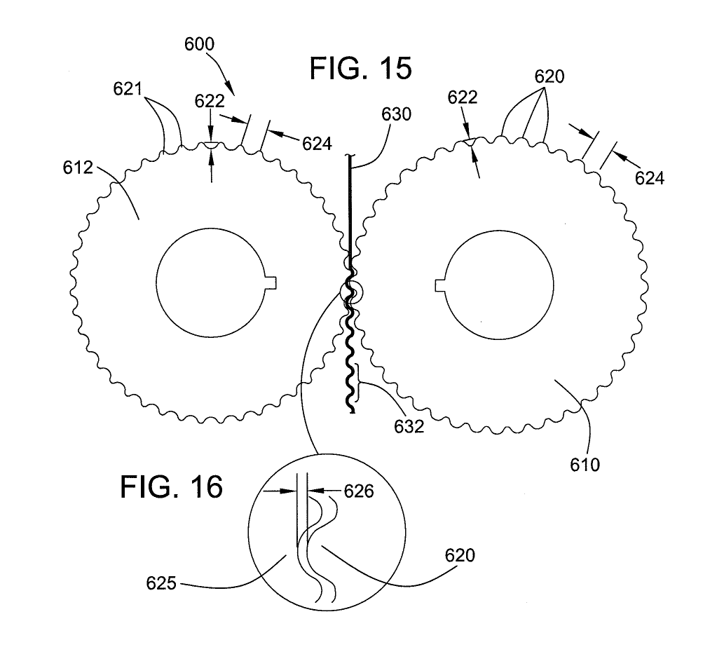

Referring to FIG. 15, there is illustrated another embodiment of a device 600 for producing a thermoplastic web having a deformed portion that utilizes rollers 610, 612 that may be made to rotate in opposite directions. The rollers 610, 612 may have formed about their sidewalls a plurality of intermeshing teeth 620, 621 corresponding to the deformation pattern. In the illustrated embodiment, the individual teeth may be rounded. The teeth 620, 621 may have a tooth height 622. The tooth height 622 may have the same dimensional information as tooth height 422. The teeth 620, 621 may have a tooth pitch 624. The tooth pitch 624 may have the same dimensional information as tooth pitch 424. Referring to FIG. 16, the rollers 610, 612 may be set apart from each other so that the peaks of the teeth 620 may be separated from the valleys 625 by a distance 626. The distance 626 may have a range from about 0.003 inches (0.008 cm) to about 0.05 inches (0.13 cm). In one embodiment, the teeth 620, 621 may fully engage the web so that the distance 626 may be approximately the thickness of the web. The smooth shape of the intermeshing teeth may help prevent ripping or tearing of the web material.

Referring to FIG. 15, a web or sheet 630 of thermoplastic material may be directed between the rotating rollers 610, 612 so that the web may be deformed with a plurality of waves 632. The waves 632 produced by rollers 610, 612 may be sinusoidal in shape. In other embodiments, the waves imparted or impressed into the web may have other suitable shapes such as, for example, saw tooth, or any type of multifaceted or polygon shape with transitions between the direction changes.

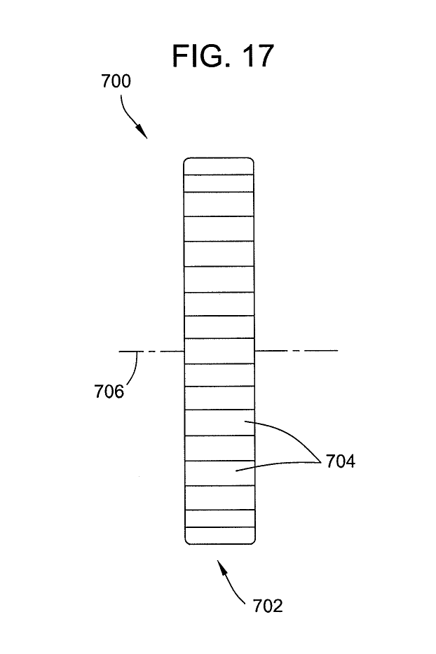

Referring to FIG. 17, there is illustrated a side view of a roller 700 for processing a web with a deformation pattern. The roller 700 may have a side surface 702 with a plurality of teeth 704 which may intermesh with teeth on a corresponding roller to create the deformation pattern. The teeth 704 may be cut into the side surface 702 parallel with the axis of rotation 706. The manner of forming the teeth into the side surface 702 may be used with any of the embodiments described herein, as appropriate.

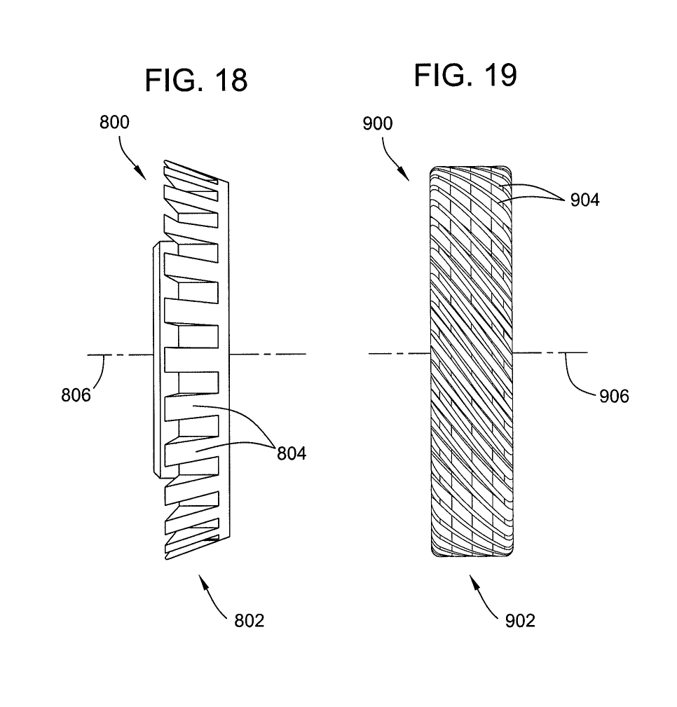

Referring to FIG. 18, there is illustrated a side view of another embodiment of a roller 800 for processing a web so as to have a deformed portion. The roller 800 may be generally shaped as a bevel gear having a non-cylindrical side surface 802. The bevel roller 800 may have a plurality of teeth 804 disposed therein that may correspond to the waves of the deformed portion that may be formed into the web. The bevel roller 800 may rotationally intermesh with a complementary bevel roller while the web may be directed and deformed therebetween. The manner of forming the teeth into the side surface 802 may be used with any of the embodiments described herein, as appropriate.

Referring to FIG. 19, there is illustrated a side view of another embodiment of a roller 900 for processing a thermoplastic web to include a deformed portion. The roller 900 may have teeth 904 that may be formed into the side surface 902 so as to rotationally wind or extend about the rotational axis line 906. The helical or winding orientation of the teeth 904 may produce a deformation pattern in which the waves intersect the bag on an angle. The manner of forming the teeth into the side surface 902 may be used with any of the embodiments described herein, as appropriate.

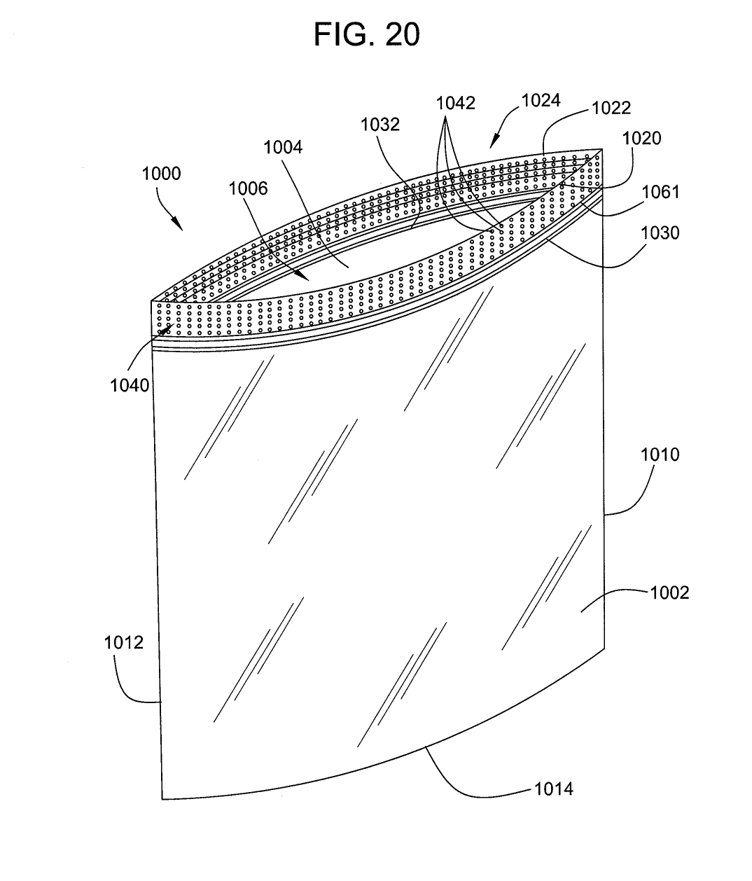

Referring to FIG. 20, there is illustrated another embodiment of a thermoplastic bag 1000 made from thermoplastic webs or sheets, a portion of which may include a deformed portion. The bag 1000 may include a sidewall 1002 that may be overlaid and joined to a second sidewall 1004 to delineate an interior volume 1006. The first and second sidewalls may be joined to each other along a first side edge 1010, a second side edge 1012, and a closed bottom edge 1014 by, for example, heat sealing. To access the interior volume 1006, the first top edge 1020 and the second top edge 1022 may remain un-joined and may delineate the rim of an opening 1024. To seal closed the opening 1024, the bag 1000 may include first and second interlocking closure strips 1030, 1032 that may be attached along the inner surfaces of the first and second sidewalls 1002, 1004 proximate to the top edges 1020, 1022. The closure strips 1030, 1032 may releasably engage and disengage to seal the interior volume 1006 from the ambient environment.

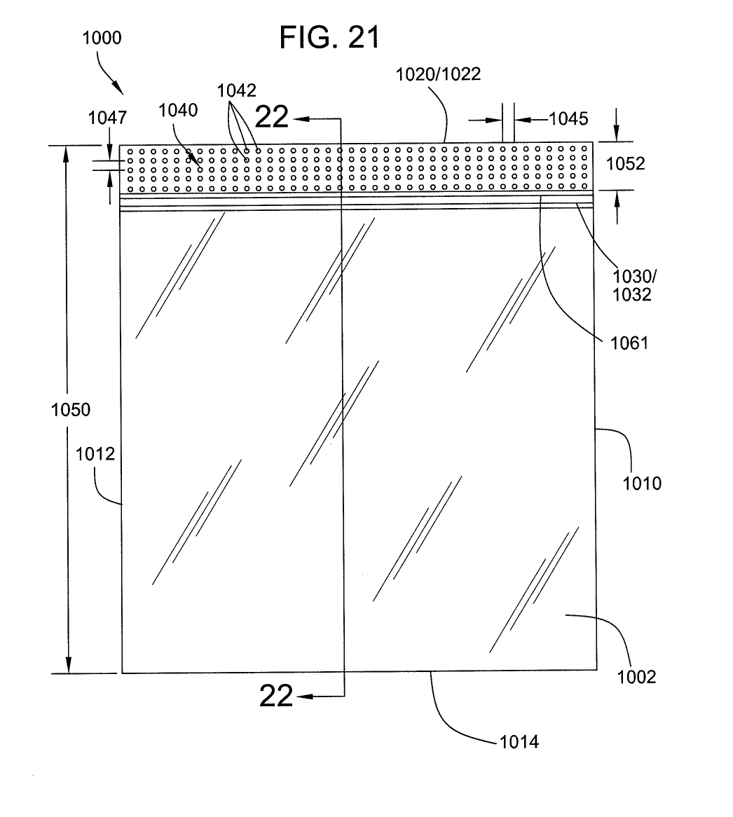

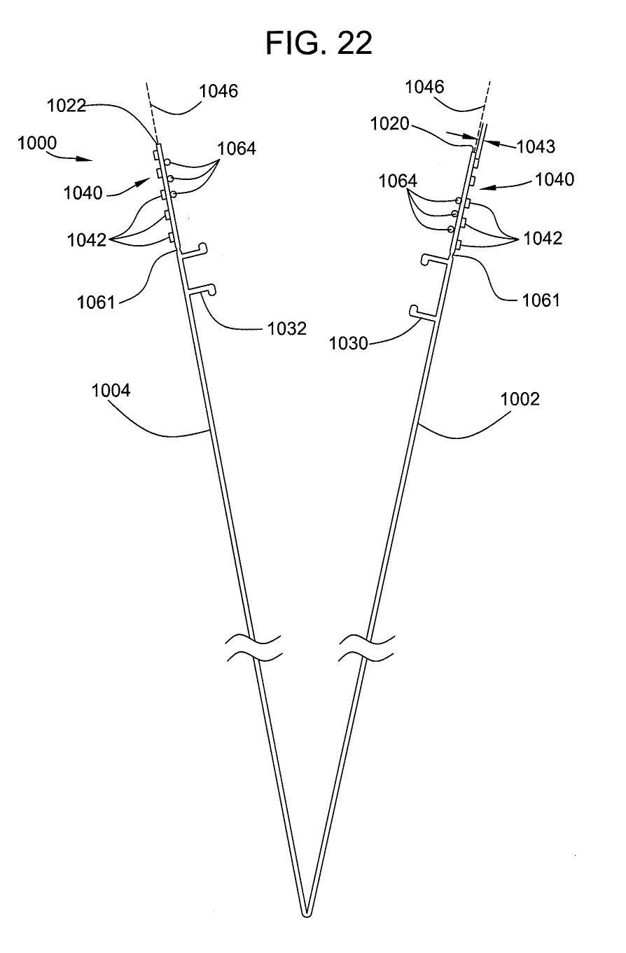

The thin-walled thermoplastic sheet or web material which may be used to make the sidewalls 1002, 1004 may be generally smooth and planar. The portion of at least one sidewall proximate the top edge 1020, 1022 may have a deformed portion 1040 to facilitate grasping and manipulating the opening. In the illustrated embodiment, the deformed portion 1040 may be provided as a plurality of protrusions 1042 that may be imparted into the material. In the illustrated embodiment, the protrusions 1042 may be circular in shape and may have a diameter. The diameter may have a first range of about 0.04 inches (0.1 cm) to about 0.2 inches (0.5 cm), a second range of about 0.06 inches (0.15 cm) to about 0.18 inches (0.46 cm), and a third range of about 0.08 inches (0.2 cm) to about 0.13 inches (0.3 cm). In one embodiment, the diameter may be about 0.1 inches (0.25 cm). The protrusions 1042 may have a height 1043 as shown in FIG. 22. The height 1043 may have a first range of about 0.02 inches (0.05 cm) to about 0.13 inches (0.3 cm), a second range of about 0.04 inches (0.1 cm) to about 0.1 inches (0.25 cm), and a third range of about 0.05 inches (0.13 cm) to about 0.08 inches (0.2 cm). In one embodiment, the height 1043 may be about 0.06 inches (0.15 cm). The protrusions 1042 may be spaced a distance 1045 as shown in FIG. 21. The distance 1045 may have a first range of about 0.08 inches (0.2 cm) to about 0.63 inches (1.6 cm), a second range of about 0.1 inches (0.25 cm) to about 0.5 inches (1.3 cm), and a third range of about 0.2 inches (0.51 cm) to about 0.38 inches (1 cm). In one embodiment, the distance 1045 may be about 0.25 inches (0.64 cm). The protrusions may be spaced a distance 1047. The distance 1047 may have a first range of about 0.08 inches (0.2 cm) to about 0.5 inches (1.3 cm), a second range of about 0.1 inches (0.25 cm) to about 0.4 inches (1 cm), and a third range of about 0.2 inches (0.51 cm) to about 0.35 inches (0.9 cm). In one embodiment, the distance 1047 may be about 0.3 inches (0.8 cm). As discussed herein, the deformed portion 1040 may cause at least a portion of the material along the top edges 1020, 1022 to be located “out of plane” with remainder of the material. This may provide the effect of there being more material or more surface area along the top edges to grasp and manipulate. The deformed portion may increase the roughness of the material proximate the first and second top edges. The deformed portion may increase the stiffness of the material proximate the first and second top edges. In other embodiments, the protrusions may have other shapes, such as, oval, obround, rectangle, square, triangle, other polygons, or any other shape, as appropriate.

Referring to FIGS. 20 and 21, the protrusions 1042 may extend proximate the top edges 1020, 1022 between the first side edge 1010 and the second side edge 1012 and may be located above the first and second closure strips 1030, 1032. As illustrated in FIG. 21, the height of the bag 1000 may extend from the top edges 1020, 1022 to the closed bottom edge 1014 a distance 1050. The distance 1050 may have the same dimensional information as distance 150. The protrusions 1042 may extend from the top edges 1020, 1022 towards the closure strips 1030, 1032 a distance 1052. The distance 1052 may have the same dimensional information as the distance 152.

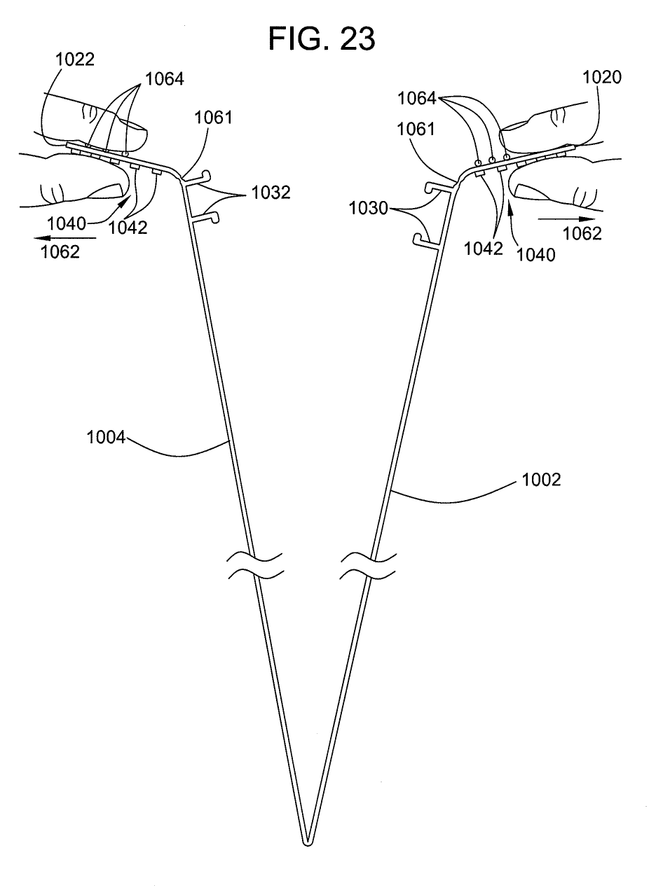

As shown in FIGS. 22 and 23, the protrusions 1042 may cause a portion of that material to become offset or lie out of a plane 1046 represented by dashed lines. A possible advantage is that the act of forming the deformed portion 1040 may form a bending line 1061 along the junction of the deformed portion and the remainder of the sidewalls 1002, 1004. In the illustrated embodiment, the bending line 1061 may be formed between the deformed portion and the closure strips 1030, 1032. When a user grasps the bag 1000 proximate the top edges 1020, 1022 and pulls them apart from each other, as indicated in FIG. 23, the top edges 1020, 1022 may bend outwards with respect to each other about the bending lines 1061. The bending line 1061 may facilitate the separation of the top edges 1020, 1022 and the flanges by the user. If the deformed portion has an increased stiffness, the increased stiffness of the deformed portion 1040 may also facilitate bending of the flanges about the bending line 1061. The bag may include beads or strips 1064 on the inner surface of the deformed portion to further assist in grasping the bag proximate the top edges. In other embodiments the bag may not include such beads or strips. The user may apply pulling forces 1062 to disengage or deocclude the closure strips 1030, 1032.

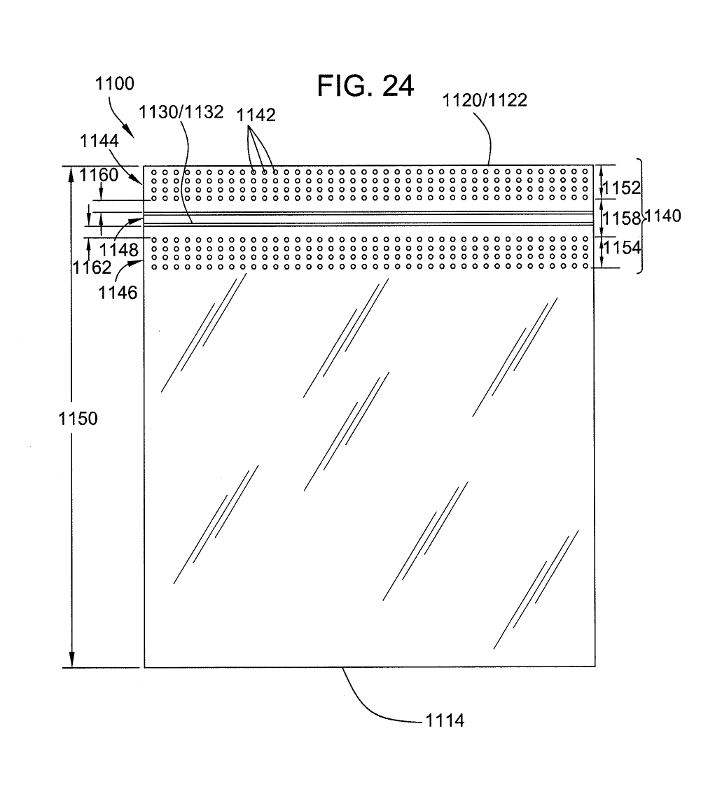

Referring to FIG. 24, there is illustrated another embodiment in which the deformed portion 1140 is imparted proximate the first and second top edges 1120, 1122 of the bag 1100 as two rows 1144, 1146. The first row 1144 of protrusions 1142 may be located above the closure strips 1130, 1132. The second row 1146 of protrusions 1142 may be located below the closure strips 1130, 1132. The rows 1144, 1146 of protrusions 1142 may provide a valley or groove 1148. As described herein, a user may use the groove 1148 as a guide or track by running their fingers along the groove to engage the closure strips 1130, 1132. As the closure strips engage, the rows 1144, 1146 and the groove 1148 may transfer to the user a tactile indication of such engagement.

The dimensions of the deformed portion 1140 may be selected to further facilitate use of the groove 1148 to engage the interlocking closure strips 1130, 1132. In the illustrated embodiment, the bag 1100 may have an overall height 1150. The height 1150 may have the same dimensional information as noted with respect to height 150 in FIG. 4. The first row 1144 may have a height 1152. The height 1152 may have the same dimensional information as height 152 in FIG. 4. The second row 1146 may have a height 1154. The height 1154 may have the same dimensional information as height 1152. The first row 1144 and second row 1146 may be separated by a distance 1158. The distance 1158 may have the same dimensional information as distance 358. The bottom of the first row 1144 may be located a distance 1160 from the top of the fastening strip 1130. The distance 1160 may have the same dimensional information as distance 360. The top of the second row 1146 may be located a distance 1162 from the bottom of the fastening strip 1130. The distance 1162 may have the same dimensional information as the distance 1160. In one embodiment, the distance 1160 may be the same as distance 1162. In another embodiment, the distance 1160 may be different than the distance 1162. The height, diameter, and spacing of the protrusions 1142 may have the same dimensional information as noted with respect to the protrusions 1042.

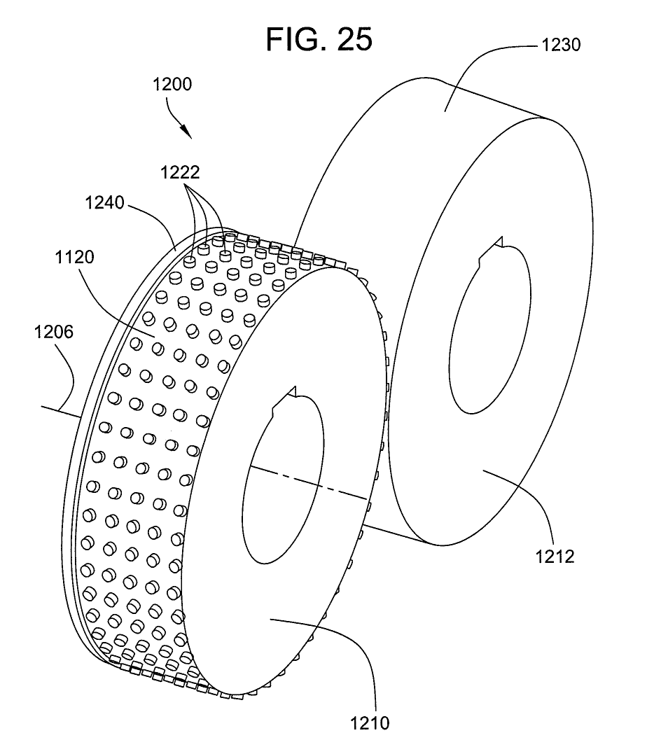

Referring to FIG. 25, there is illustrated a processing device 1200 which may be used to impart the deformation pattern into the material. The processing device may utilize a first roller 1210 and an opposing second roller 1212. The rollers 1210, 1212 may be arranged in parallel and may be adjacent to each other. The rollers may be made to rotate in opposite directions with respect to each other. The first roller 1210 may include extending radially about its sidewall 1220 a plurality of circular protrusions 1222. The protrusions 1222 may be arranged in parallel rows aligned with the axis 1206 of the first roller. The protrusions 1222 may correspond to the protrusions to be imparted onto the thermoplastic web. The second roller 1212 may be a resilient material, such as, rubber or elastomeric, or the roll may be made of a hard material with the sidewall 1230 made of a resilient material. In another embodiment, the second roller may have a pattern which receives the protrusions, such as, a plurality of detents. In another embodiment, the first roller may have a pattern of protrusions and detents and the second roller may have a pattern of protrusions and detents. The protrusions in the first roller may engage the detents in the second roller and the protrusions in the second roller may engage the detents in the first roller. When the bag is processed by such rollers, the bag may have protrusions on both sides of the sidewall.

As the first and second rollers 1210, 1212 are rotated in opposite directions to each other and a thermoplastic web or sheet is directed therebetween, the protrusions 1222 of the first roller may be imparted into the web or sheet. The forming may occur without cutting or tearing the material of the web or sheet. The action forms the web or sheet with protrusions corresponding to the protrusions 1222 on the first roller 1210. In various embodiments, imparting the protrusions into the roller may stretch out or work the thermoplastic material so as to retain the shape of the protrusions. Additionally, stretching and working the material may provide increased stiffness to the material.

The first roller 1210 may include a rib 1240. The rib 1240 may be used to form the bending line 1061 as shown in FIG. 22. Referring to FIG. 25, the rib 1240 may engage the web or sheet material and may cause the material to become thinner by displacing material at the rib 1240. The location of the thinner material may become the bending line 1061. In other embodiments, the first roller may not include the rib.

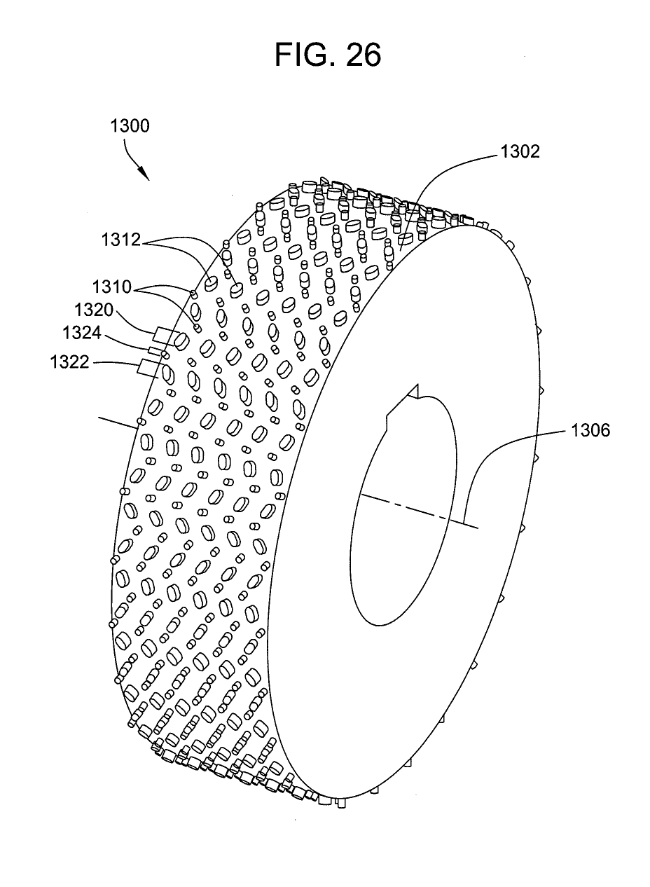

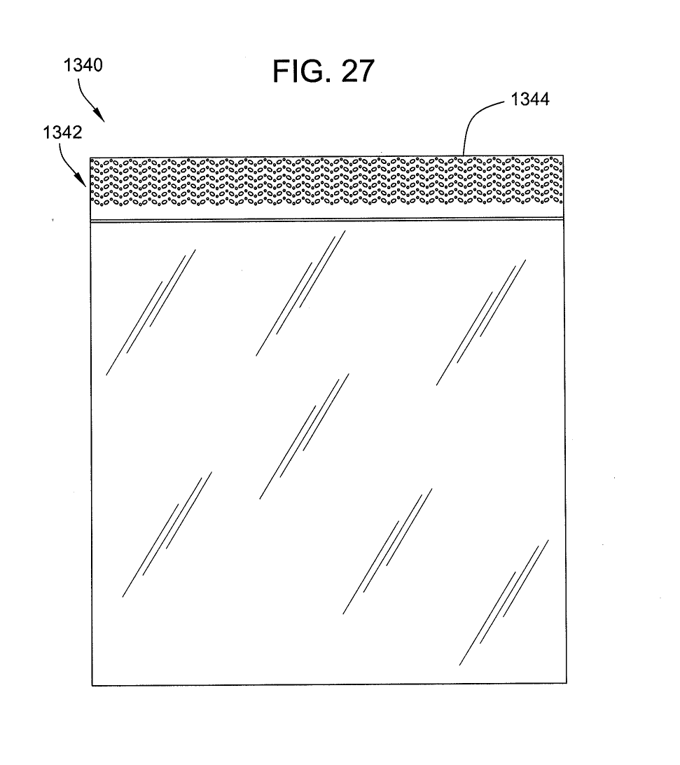

Referring to FIG. 26 there is illustrated a roller 1300 for forming a portion of a thermoplastic web in a particular pattern. The roller 1300 may include multiple types of protrusions projecting from the sidewall 1302 including, for example, circular protrusions 1310 and oval or obround protrusions 1312. The circular and obround protrusions may be arranged in parallel rows aligned to the axis 1306 of the roller 1300 with the rows alternating between circular protrusions and obround protrusions. The obround protrusions 1312 may be angularly oriented on the cylindrical sidewall 1302 with respect to the axis line. For example, the obround protrusions 1312 may be grouped into adjacent rows 1320, 1322 wherein the obround protrusions in each row may be angled axially forward towards a common row 1324 of circular protrusions therebetween. The roller 1300 may be used with any of the embodiments of a second roller as described herein, as appropriate. A bag 1340 produced by the roller 1300 of FIG. 26 is depicted in FIG. 27. The patterning of obround protrusions and circular protrusions may produce a deformed portion 1342 including adjacent zigzag lines of protrusions which may be parallel to the top edges 1344 of the bag.

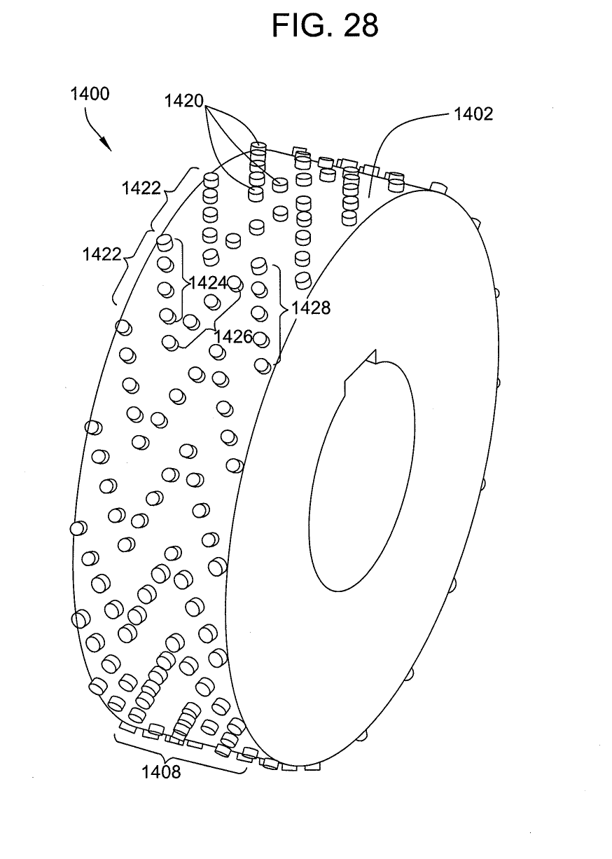

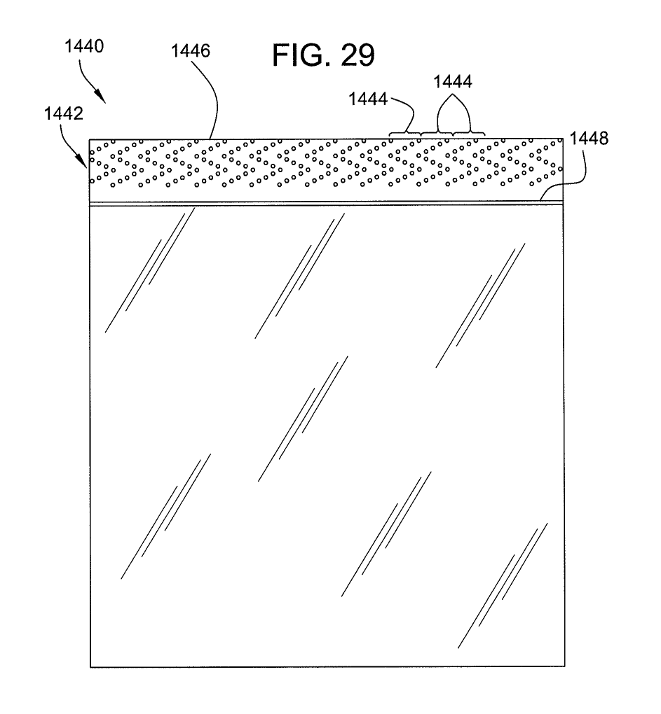

Referring to FIG. 28, there is illustrated another embodiment of a roller 1400 for forming a thermoplastic web in a particular pattern. The roller 1400 may include a plurality of circular protrusions 1420 projecting from the sidewall 1402 and may be arranged to produce a zigzag pattern. The protrusions 1420 may be arranged in groups 1422 that may extend across the width 1408 of the roller 1400 and that may be placed circumferentially about the sidewall 1402. Each group 1422 may include a first series 1424 of protrusions that may extend in a first direction, a second series 1426 of protrusions that may extend in a second direction, and a third series 1428 that may extend in a third direction that may be parallel to the first direction. A bag 1440 produced by the cylindrical roller 1400 of FIG. 28 is depicted in FIG. 29. The portion 1442 may include multiple, adjacent zigzag lines 1444 of circular protrusions that may extend from the top edge 1446 toward the closure strips 1448.

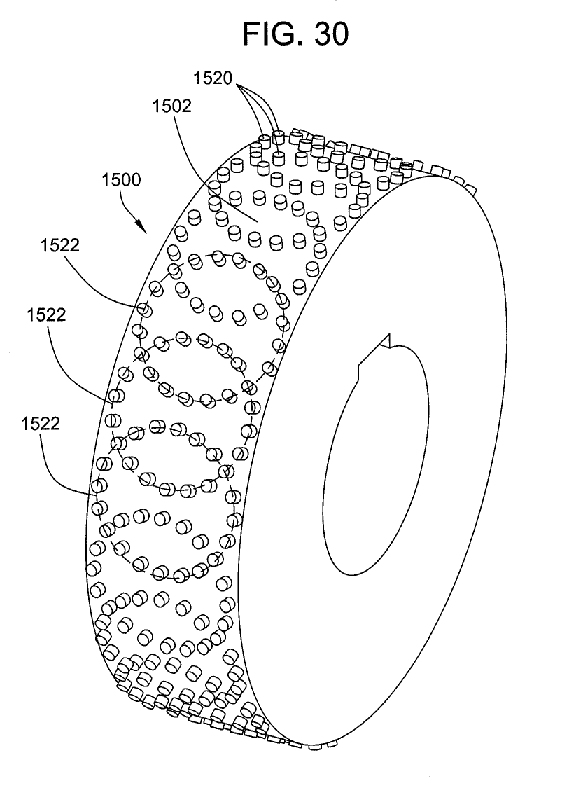

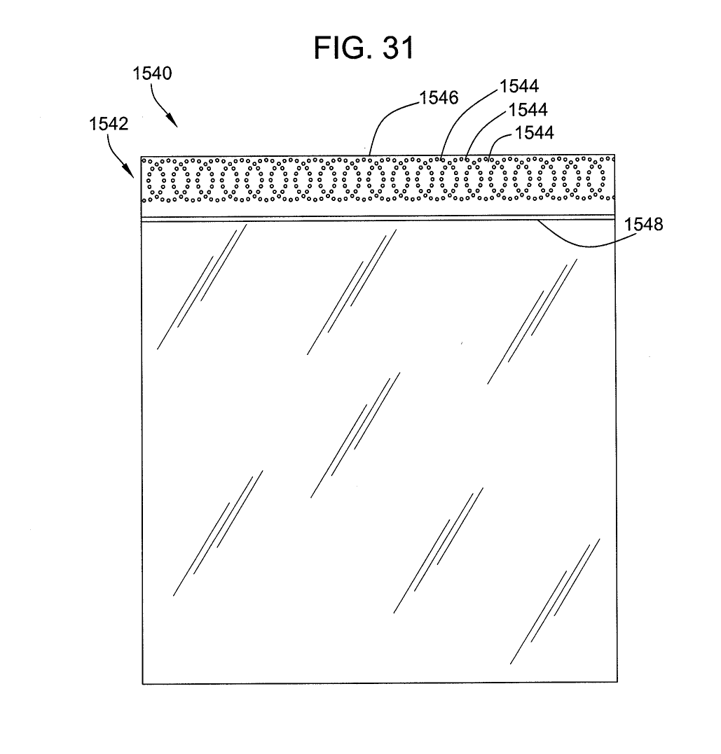

Referring to FIG. 30, there is illustrated another embodiment of a roller 1500 for forming a thermoplastic web in a particular pattern. The roller 1500 may include a plurality of circular protrusions 1520 projecting from the sidewall 1502 and may be arranged to produce a pattern of interlinking circles. The protrusions 1520 may be arranged in a plurality of circles 1522 indicated by dashed lines. Each of the circles 1522 may partially overlap with adjacent circles so that they appear interlinked. A bag 1540 produced by the cylindrical roller 1500 of FIG. 30 is depicted in FIG. 31. The portion 1542 may include multiple, interlinked circles 1544 of protrusions which may be located between the top edges 1546 and the closure strips 1548.

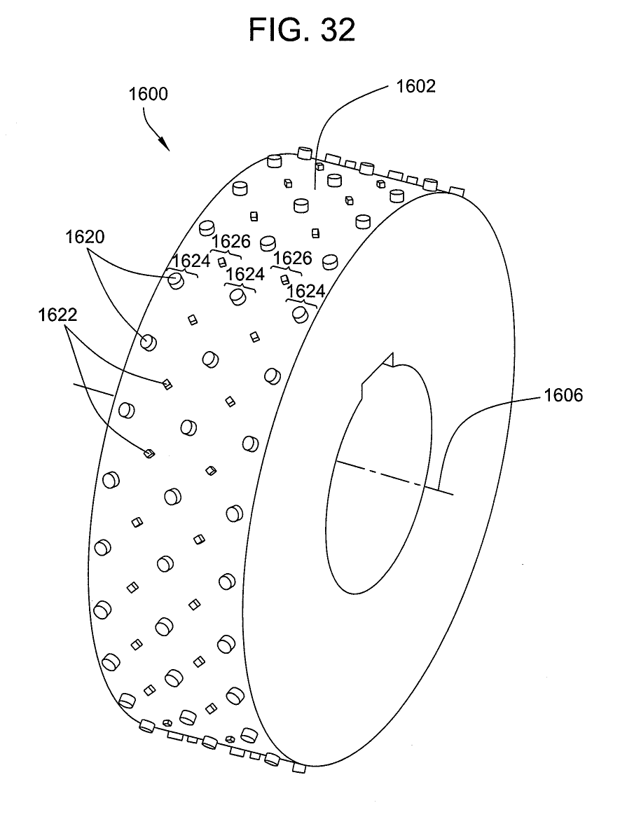

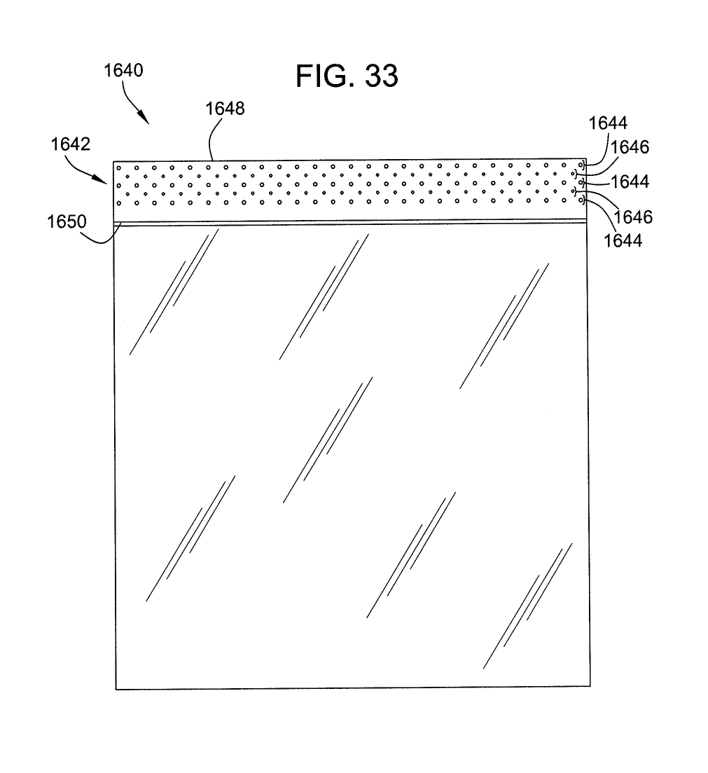

Referring to FIG. 32, there is illustrated another embodiment of a roller 1600 for forming a thermoplastic web in a particular pattern. The roller 1600 may have multiple types of protrusions including circular protrusions 1620 and diamond protrusions 1622 that may project outward from the sidewall 1602 of the roller. The circular protrusions 1620 and the diamond protrusions 1622 may be arranged in alternating, circumferential rows that may extend circumferentially around the axis line 1606 of the roller. For example, the roller 1600 may include three circumferential rows 1624 of circular protrusions 1620 that may be spaced axially along the roller 1600 and that may be separated from each other by one of two circumferential rows 1626 of diamond protrusions 1622. A bag 1640 produced by the roller 1600 of FIG. 32 is depicted in FIG. 33. The portion 1642 may include alternating rows 1644 of circular protrusions and rows 1646 of diamond protrusions that may extend parallel to the top edges 1648 and the closure strips 1650.

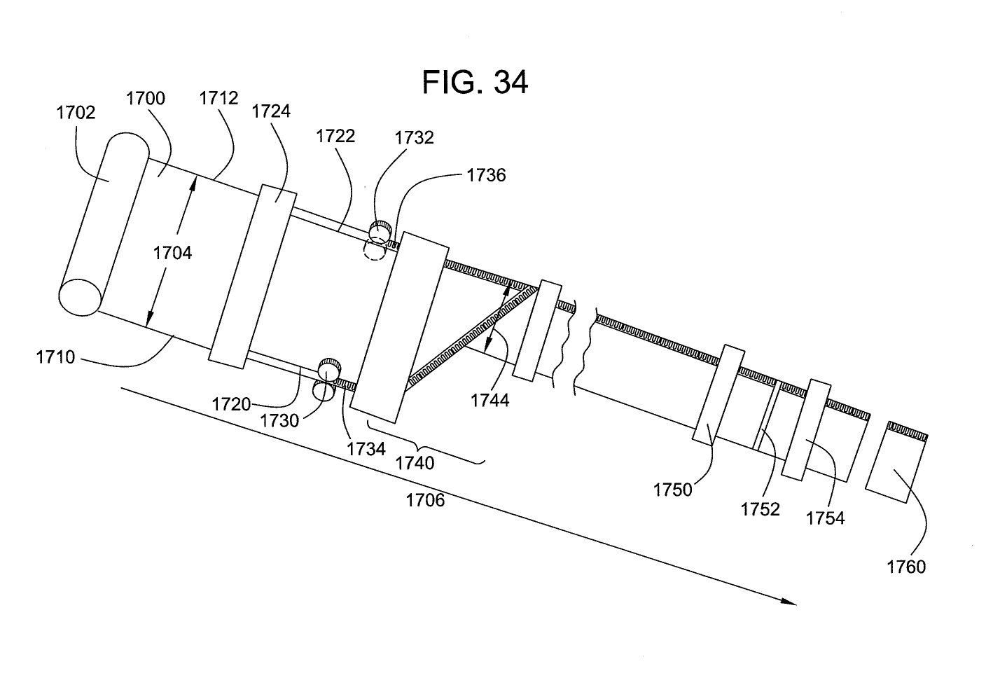

Manufacturing of a bag with a deformed portion along its top edges may be accomplished in a number of different ways. To minimize the incremental costs of the bags, manufacturing may be accomplished in a high-speed automated process. For example, referring to FIG. 34, there is illustrated a schematic of an embodiment for high-speed automated manufacturing of bags. Production of the bags may start with providing a web 1700 of pliable thermoplastic material wound into a roll 1702. The web 1700 may have a width 1704 as measured between the first and second side edges 1710, 1712. The web 1700 may be unwound from the roll and may be directed along a machine direction 1706. In another embodiment, the web 1700 may be extruded as part of the manufacturing process. The web 1700 may be directed through a machine 1724 that may attach the first and second interlocking closure strips 1720, 1722 near the respective first and second edges 1710, 1712.

The deformation pattern may be applied to a portion of the web. To apply the deformation pattern, the processing equipment may include a first pair of adjacent, opposing rollers 1730 and a second pair of adjacent opposing rollers 1732. The rollers 1730, 1732 may have formed about their sidewalls a pattern, such as any of the patterns described herein, as appropriate. The rollers 1730, 1732 may be oriented so that their axes are perpendicular to the machine direction 1706. The first pair of rollers 1730 may be located so that material proximate the first side edge 1710 may be directed between rollers 1730 while the second pair of rollers 1732 may be located so that material proximate the second side edge 1712 may be directed between rollers 1732. The first and second rollers 1730, 1732 may be spaced beyond the attached closure strips 1720, 1722. The rollers may be synchronized to rotate in registration with the advancement of the web 1700 along the machine direction 1706. As the web passes between the rollers, the rollers 1730, 1732 may impart their pattern into the thermoplastic web material to form the portions 1734, 1736 of the bag. The pattern may be formed about the sidewall of the rollers in order to avoid cutting or tearing the webs. The attached closure strips 1720, 1722 may pass to the side of the rollers 1730, 1732 so as to avoid deformation.

The web 1700 may then be folded in half via a folding operation 1740 so that the first edge 1710 may be moved adjacent the second edge 1712. The web 1700 may have a width 1744 that may be half of the initial width 1704. Also, the fastening strips 1720, 1722 may be adjacent and opposite each other after folding.

The web may be directed through other processing steps to further process the finished bag. For example, the web 1700 may be directed through a side sealing operation 1750 in which the folded web may be sealed together by side seals 1752. The side seals 1752 may correspond to the side edges of the finished bag. The web may be directed through a cutting operation 1754 so that individual bags 1760 may be separated from the web and placed in packaging. In another embodiment, the side seal and cutting operations may be performed at the same time.

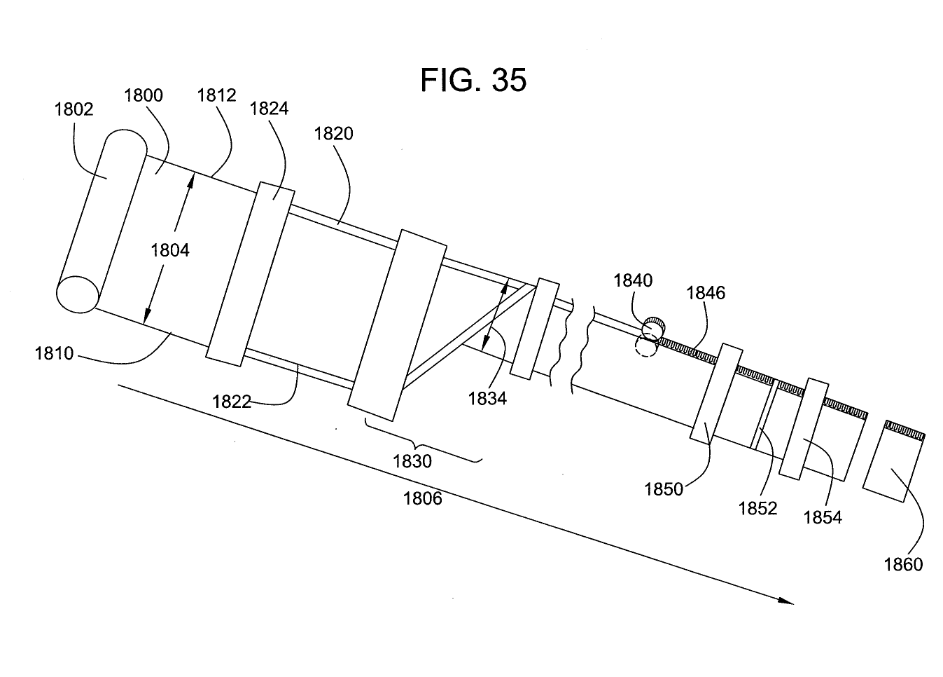

Referring to FIG. 35, there is illustrated another embodiment of a manufacturing process for making the thermoplastic bag having a deformed portion for improved occlusion. Similar to the process depicted in FIG. 34, the process of FIG. 35 may utilize a single roll 1802 of thermoplastic web or sheet material 1800 that may be unwound and may be directed along a machine direction 1806. The web 1800 may have an initial width 1804 measured between a first edge 1810 and a second edge 1812. The web 1800 may be directed through a machine 1824 that may attach the first and second interlocking closure strips 1820, 1822 near the respective first and second edges 1810, 1812.

The web 1800 may be folded in half via a folding operation 1830 so that the first edge 1810 may be moved adjacent to the second edge 1812. Additionally, the first and second interlocking closure strips 1820, 1822 may be moved parallel and adjacent to each other. After folding, the web 1800 may have a new width 1834 that may be about half of the width 1804.

To apply a deformation pattern and deform the web 1800, the processing equipment may include a pair of opposing rollers 1840 located downstream from the folding operation 1830. The rollers 1840 may have formed about their sidewalls a deformation pattern, such as any of the patterns discussed herein. The rollers 1840 may impart their pattern into the thermoplastic material thereby deforming the portion 1846 of the web proximate the adjacent edges 1810, 1822. The deformed portion 1846 may be imparted into both the first and second web halves. Because the first and second edges 1810, 1812 may be adjacent to each other, only one pair of opposing rollers 1840 may be needed to deform the bag.

As with the process shown in FIG. 34, the web maybe directed through a series of other processing steps to produce the finished bags 1860. These steps may include a side sealing operation 1850 that may form side seals 1852 across the width of the folded web 1800. The web may be directed through a cutting operation 1854 to detach individual bags 1860 from the rest of the web 1800. In another embodiment, the side seal and cutting operations may be performed at the same time.

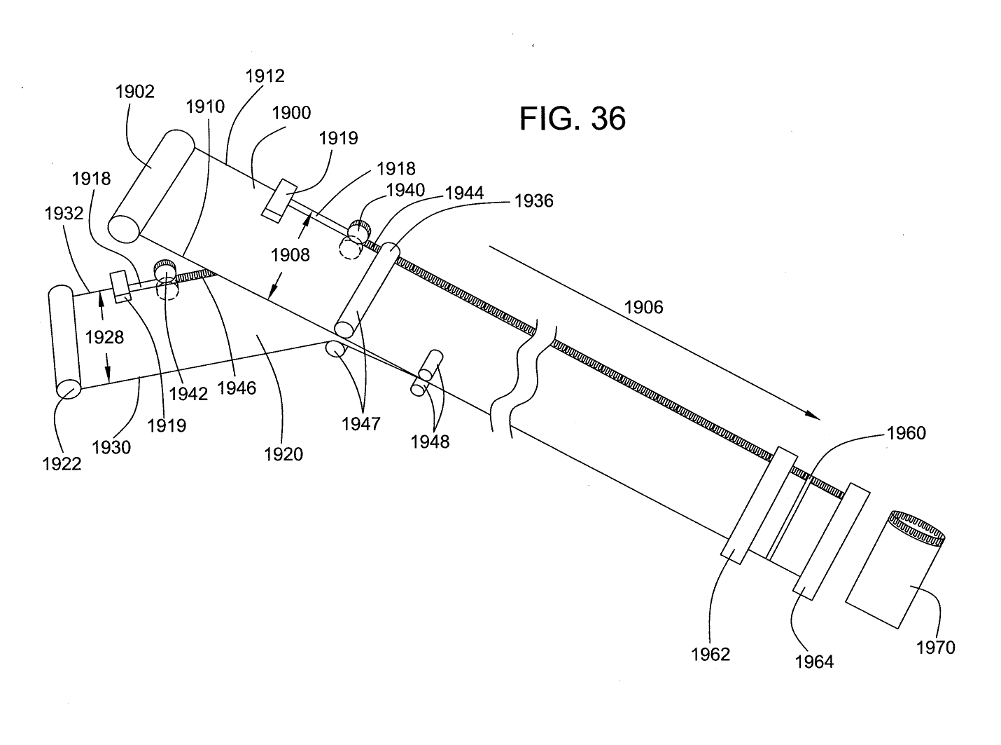

Referring to FIG. 36, there is illustrated another embodiment of a manufacturing process for producing a thermoplastic bag for storing food items. The process may employ multiple thermoplastic webs including a first web 1900 which may be wound into a first roll 1902 and a second web 1920 which may be wound into a second roll 1922. The first web 1900 may be unwound and may be directed in a machine direction 1906 by the processing equipment. The first web 1900 may have a width 1908 as measured between the first and second side edges 1910, 1912. The second web 1920 may have a width 1928 measured between the first and second side edges 1930, 1932 of the second web. The first and second widths 1908, 1928 may be equal. In another embodiment, the webs 1900, 1920 may be extruded as part of the process. In addition, the processing equipment may include appropriately placed devices 1919 that may attach fastening strips 1918 to the surfaces of the webs 1900, 1920 proximate the respective second edges 1912, 1932 of the webs.

To provide the deformed portions of the webs, the processing equipment may include a first pair of opposing rollers 1940 that may deform the first web 1900 and a second pair of opposing rollers 1942 that may deform the second web 1920. Each pair of rollers 1940, 1942 may have formed about their sidewalls a deformation pattern, such as any of the patterns discussed herein. The rollers 1940 may deform that portion 1944 of the web 1900 that is proximate the first edge 1910. The second pair of rollers 1942 may impart a deformation pattern onto the second web 1920 proximate the first edge 1932 to provide the deformed portion 1946.

After forming the deformed portions 1944, 1946 into the first and second webs 1900, 1920, the first and second webs may be aligned and may be joined together. For example, the second web 1920 may be directed by appropriately placed rollers 1947 or bars to be parallel and adjacent to the first web 1900 and may be directed along the machine direction 1906. Accordingly, the edges 1910, 1912 of the first web 1900 and the edges 1930, 1932 of the second web 1920 may be adjacent to and aligned with each other. The adjacent edges 1910, 1930 may be joined together, such as by passing the webs 1900, 1920 together between appropriately located rollers 1948 and the use of heat.

The joined webs may be directed through additional processing equipment to produce the finished bag 1970. For example, the processing environment may include a sealer 1962 that may form the side seals 1960. Additionally, the webs 1900, 1920 may be directed through a cutting operation 1964 to create individual bags 1970. In another embodiment, the side seal and cutting operations may be performed at the same time.

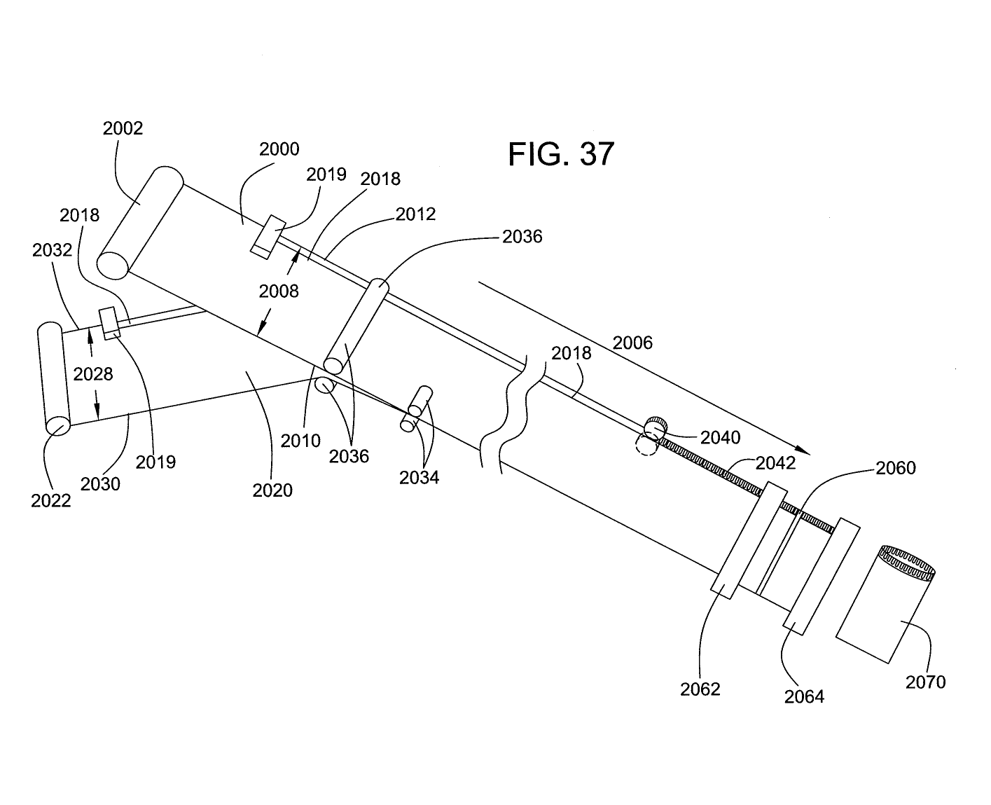

Referring to FIG. 37, there is illustrated another embodiment of a process for manufacturing a thermoplastic bag that may utilize multiple webs 2000, 2020 of thermoplastic material. Like the process depicted in FIG. 36, the process of FIG. 37 may unwind a first web 2000 from a first roll 2002 and may direct the web along the machine direction 2006. The web 2000 may have a first width 2008 measured between first and second side edges 2010, 2012. A second web 2020 may be unwound from a second roll 2022 and may have a second width 2028 measured between first and second side edges 2030, 2032. The closure strips 2018 may be attached to the webs 2000, 2020 proximate one of the respective edges 2012, 2032 on each of the webs. To bring the first and second webs 2000, 2020 adjacent to and aligned with each other, the second web may be redirected by appropriately placed rollers 2036 to run parallel with the first web. The first and second webs may be joined together, such as, by running the edges 2010, 2030 between rollers 2034 and the use of heat.

The webs may be deformed to provide the deformed portion that may be adjacent the opening of the finished bag. To deform the webs, a pair of opposing rollers 2040 may be located so that the material proximate the second edges 2012, 2032 may be directed therebetween. The rollers 2040 may have formed about their sidewalls a deformation pattern such as any of the patterns described herein. The rollers may impart the pattern into the thermoplastic material of the webs 2000, 2020 to provide the deformation portion 2042.

The webs 2000, 2020 may be directed through various processing steps to produce the finished bags 2070. These steps may include a side sealing operation 2062 that forms side seals 2060 in the thermoplastic web material. The webs 2000, 2020 may be directed through a cutting operation 2064 through which individual bags 2070 are cut from the web material. In another embodiment, the side seal and cutting operations may be performed at the same time.

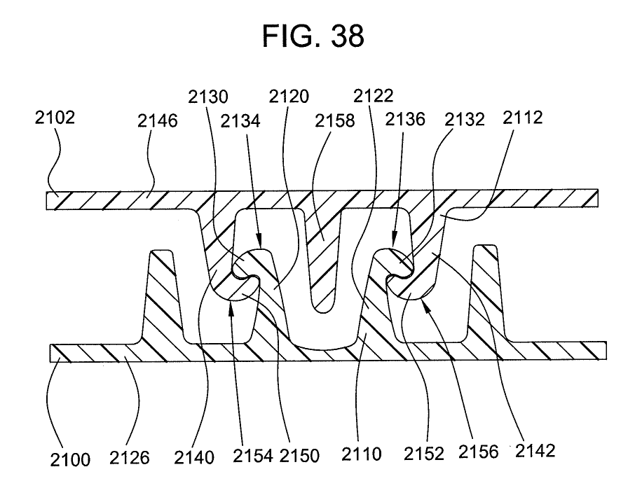

The flexible bag may be provided with different embodiments of closure strips and the closure strips may be activated by a user's fingers. For example, referring to FIG. 38, there is shown the closure strips in the form of U-channel closure strips as described in U.S. Pat. No. 4,829,641, herein incorporated by reference in its entirety. U-channel fastening strips include a first fastening strip 2100 with a first closure element 2110 and a second fastening strip 2102 with a second closure element 2112. The first and second closure elements 2110, 2112 may be produced by extruding or molding a suitable thermoplastic material. The first closure element 2110 engages the second closure element 2112. In the illustrated embodiment, the first closure element 2110 includes a first arm-like web 2120 and a spaced apart second arm-like web 2122 that project from a base portion 2126. Formed at the distal ends of each of the webs 2120, 2122 are a first hook portion 2130 and a respective second hook portion 2132. The webs 2120, 2122 are arranged so that the hook portions 2130, 2132 are directed away from each other. Additionally, the hook portions 2130, 2132 may shaped to form a rounded guide surface 2134, 2136 at the distal ends of the webs 2120, 2122.

The second closure element 2112 also includes a third arm-like web 2140 and a fourth arm-like web 2142 that are spaced apart from each other and that project from a base portion 2146. The spacing between the third and fourth arms 2140, 2142 may be greater than the spacing between the first and second webs 2120, 2122. Formed at the distal end of each of the webs 2140, 2142 are respective first and second hook portions 2150, 2152. The third and fourth webs 2140, 2142 are arranged so that the hook-portions 2150, 2152 face towards each other. The hook portions 2150, 2152 may be shaped to form rounded guide surfaces 2154, 2156 at the distal ends of the third and fourth webs 2140, 2142. The second closure element 2112 may also include a projecting center flange 2158 that is located between the first and second webs 2140, 2142.

In operation, the first closure element 2110 and the second closure element 2112 are moved towards each other so that the guide surface 2134 on the first web 2120 contacts the guide surface 2154 of the third web 2140. This action may also cause the guide surface 2136 of the second web 2122 to contact the guide surface of the fourth web 2142. The first and second webs 2120, 2122 may flex towards each other while the third and fourth webs 2140, 2142 may flex apart from each other as the guide surfaces contact and move with respect to each other. This motion enables the hook portions 2130, 2132 of the first and second webs 2120, 2122 to hook around and engage the hook portion 2150, 2152 of the third and fourth webs 2140, 2142. As can be appreciated from FIG. 38, once the hook portions 2130, 2132, 2150, 2152 hook around and engage each other, the first and second fastening strips 2100, 2102 are interlockingly engaged. To disengage the strips, the first and second closure elements 2110, 2112 are pulled away from each other.

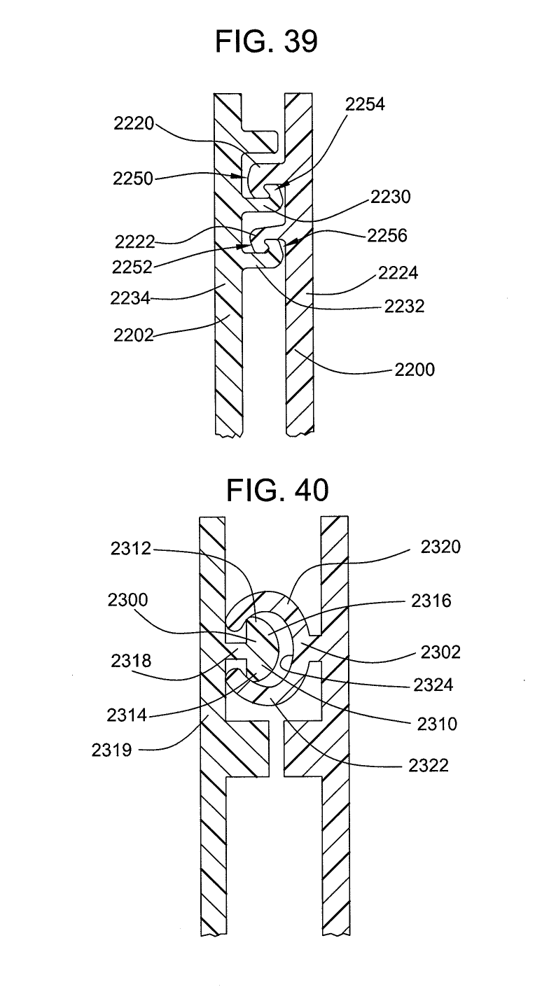

Furthermore, the interlocking fastening strips may comprise “profile” closure strips, as shown in FIG. 39 and described in U.S. Pat. No. 5,664,299, herein incorporated by reference in its entirety. As shown in FIG. 39, the first profile 2200 has at least a first uppermost closure element 2220 and a second bottommost closure element 2222. (U.S. Pat. No. 5,664,299, Col. 3, lines 25-27). The first and second closure elements 2220, 2222 project laterally from the inner surface of the strip 2224. (U.S. Pat. No. 5,664,299, Col. 3, lines 27-28). Likewise, the second profile 2202 has at least a third uppermost closure element 2230 and a fourth bottommost closure element 2232. (U.S. Pat. No. 5,664,299, Col. 3, lines 28-30). The third and fourth closure elements 2230, 2232 project laterally from the inner surface of a strip 2234. (U.S. Pat. No. 5,664,299, Col. 3, lines 30-32). When the bag is closed, the first and second profiles 2200, 2202 interlock with each other. (U.S. Pat. No. 5,664,299, Col. 3, lines 32-34).

As shown in FIG. 39, the first and third uppermost closure elements 2220, 2230 are formed to have hooks 2250, 2254 on their distal ends and the second and fourth bottommost closure elements 2222, 2232 are also formed to have hooks 2252, 2256 on their distal ends, so that the profiles remain interlocked when the bag is closed, thereby forming a seal. (U.S. Pat. No. 5,664,299, Col. 3, lines 34-37). The first and second closure elements 2220, 2222 are arranged so that the hooks 2250, 2252 are both directed downward while the third and fourth closure elements 2230, 2232 are arranged so that the hooks 2254, 2256 are both direct upwards. When the first and second profiles 2200, 2202 are pressed towards each other, the hooks 2250, 2252, 2254, 2256 may move around and hook behind each other.

The interlocking fastening strips may comprise “arrowhead-type” or “rib and groove” fastening strips as shown in FIG. 40 and as described in U.S. Pat. No. 3,806,998, herein incorporated by reference in its entirety. The rib element 2300 interlocks with the groove element 2302. The rib element 2300 is of a general arrow-shape in transverse cross section and includes a head 2310 comprising interlock shoulder hook portions 2312 and 2314 generally convergently related to provide a cam ridge 2316. The cam ridge 2316 is generally aligned with a stem flange 2318 by which the head 2310 is connected in a spaced relation with respect to the supporting flange portion 2319. (U.S. Pat. No. 3,806,998, Col. 2, lines 16-23). At their surfaces nearest the connecting stem flange 2318, the shoulder portions 2312 and 2314 define reentrant angles therewith providing interlock hooks that are engageable with interlock hook flanges 2320, 2322, respectively, of the groove element 2302. (U.S. Pat. No. 3,806,998, Col. 2, lines 23-28). The hook flanges 2320, 2322 generally converge toward one another and are spread open to receive the head 2310 therebetween when the head is pressed into said groove element 2302 until the head is fully received in a groove 2324 of the groove element. The groove 2324 may be shaped generally complementary to the head 2310 and within which the head is interlocked by interengagement of the shoulder hook portions 2312, 2314 and the groove hook flanges 2320, 2322. (U.S. Pat. No. 3,806,998, Col. 2, lines 28-36). Through this arrangement, as indicated, the head 2310 and groove elements 2302 are adapted to be interlockingly engaged by being pressed together and to be separated when forcibly pulled apart. As explained in U.S. Pat. No. 3,806,998, a generally U-shaped slider may be provided to facilitate engagement and disengagement of the head and groove elements. (U.S. Pat. No. 3,806,998, Col. 2, lines 36-41).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those embodiments may become apparent to those of ordinary skill in the art upon reading the foregoing description. The inventor(s) expect skilled artisans to employ such variations as appropriate, and the inventor(s) intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A flexible thermoplastic bag comprising:
a first sidewall of thermoplastic material;
a second sidewall of thermoplastic material overlaid and joined to the first sidewall to provide an interior volume, the interior volume accessible via an opening, the bag includes first and second top edges; and
first and second interlocking closure strips;
wherein the bag includes a deformed portion located between the first closure strip and the first top edge.

2. The bag of claim 1, wherein a portion of the deformed portion is located out of plane with a plane delineated prior to the deformation.

3. The bag of claim 1, wherein the second sidewall includes a second deformed portion located between the second closure strip and the second top edge.

4. The bag of claim 3, wherein third and fourth deformed portions are located respectively below the first and second closure strips.

5. The bag of claim 3, wherein the first and second deformed portions on the respective first and second sidewalls extends between the first side edge and the second side edge.

6. The bag of claim 1, wherein the deformed portion is a wavy pattern of crests.

7. The bag of claim 1, wherein the deformation pattern includes a plurality of protrusions.

8. The bag of claim 7, wherein the shape of the protrusions are selected from the group consisting of circular, obround, and diamond.

9. The bag of claim 1, wherein the deformed portion forms a bend line.

10. The bag of claim 1, wherein the deformed portion is a bend line.

11. The bag of claim 10, wherein the bend line enables the first top edge to bend with respect to the material below the bend line.

12. The bag of claim 1, wherein the first and second deformed portions have an increased stiffness compared to the first and second sidewalls without the deformed portions.

13. A method of manufacturing a thermoplastic bag comprising:
directing a first web of flexible thermoplastic material along a machine direction;
attaching a first interlocking fastening strip to the web;
attaching a second interlocking closure strip to the web;
directing a portion of material above the first closure strip between opposing first and second rollers, at least one of the first and second rollers including a deformation pattern; and
forming a deformed portion in the material corresponding to the deformation pattern.

14. The method of claim 13, further comprising the steps of:
directing a portion of material above the second closure strip between opposing third and fourth rollers, at least one of the third and fourth rollers including a second deformation pattern; and
forming a second deformed portion in the material corresponding to the second deformation pattern.

15. The method of claim 13, further comprising the step of:
folding the web prior to the step of directing the web between the first and second rollers.

16. The method of claim 13, wherein the deformed portion is a wavy pattern of spaced-apart crests.

17. The method of claim 13, wherein the deformed portion includes a plurality of protrusions.
